(19) United States
(12) Patent Application Publication
(10) Pub. No.: US 2004/0055005 A1
(43) Pub. Date: Mar. 18, 2004

(54) Data processing apparatus, method and system

(76) Inventors: Dan Creswell, Shinfield Road (GB); Nigel Warren, Windsor (GB)

Correspondence Address: HARRINGTON & SMITH, LLP, 4 RESEARCH DRIVE, SHELTON, CT, 06484-6212, US

(21) Appl. No.: 10/297,044

(22) PCT Filed: May 31, 2001
(86) PCT No.: PCT/GB01/02421

(30) Foreign Application Priority Data
May 31, 2000 (GB) 0013269.6

(51) Int. Cl. G06F 9/00

(52) U.S. Cl. 719/315

(57) ABSTRACT

A data processing apparatus for providing an object-oriented execution environment, such as a virtual machine operable for first and second versions of the same class is disclosed. The data processing apparatus communicates with first and second services respectively operative for first and second versions of the same class. However, the first service is allowed to communicate only with a first version execution environment, and the second service is allowed to communicate only with a second version execution environment. The data processing apparatus is configured so that different versions of a class can share data or information between them.

The present invention relates to a data processing apparatus, method and system. In particular, but not exclusively, to data processing apparatus, method and system operating an object-oriented environment supporting dynamic class loading.

Object-oriented programming languages such as C++, JAVA and Smalltalk are highly structured and formalised languages which follow strict rules. The aim of such languages is to enhance the modularity, reliability, robustness and reusability, amongst other things, of computer program code written in the object-oriented language. A particular feature of object-oriented programming languages is the ability of the system and/or user to define one or more classes, each class defining an abstract data type and its partial or total implementation. An instance of a class is an object and the class defines the list of operations, or features, which may be applied to the objects within that class, and the properties of these objects.

Classes can be formed into hierarchies. In JAVA these are linear and in C++ these can be trees or graphs. For example, in a JAVA based stock control system for a greengrocers shop:

Apple could inherit from Fruit;

Fruit could inherit from Food;

Food could inherit from Stock; and

Stock could inherit from Object.

Thus, a super class structure is created often in the form of a list, tree or graph containing the whole class structure all the way up to the base class (which in JAVA is always the class Object). So, for the above example, class Apple extends class Fruit;

class Fruit extends class Food;

class Food extends class Stock; and

class Stock extends class Object.

An array describing the super class structure would contain “Apple”, “Fruit”, “Food”, “Stock” and “Object”.

In JAVA syntax, the Object class is always the base class because the rules of JAVA define it as being the final parent class.

Within an object-oriented environment, an object cannot exist unless it falls within a predefined class; an attempt to use an object which is not within a predefined class will result in an error message being generated by the program compiler, or interpreter, indicating that a class has not been defined. The class-object structure provides a powerful means for managing data types within a programming environment. For the present application, the term “object-orientation” and the like shall be taken to refer to environments which have at least a class-object structure. An example of an object-oriented environment is a JAVA virtual machine.

Although the control afforded by object-oriented programming languages is a powerful means by which to manage the structure and design of the language, and application programs written in the language, such control does have drawbacks in certain situations where it is desirable or necessary to update a class and to create a new version of that class. An example of such a situation is where a merchant provides an e-commerce service to customers via a computer network such as an Internet. For example, a mail order catalogue service. The software which provides the mail order service runs in an object-oriented language on the merchant's e-commerce server. A class may be defined which describes an object such as a “book” having the attributes “title” and “dollar price”. After some time, the merchant realises that their business is successful and wishes to expand it to territories outside the United States. In order to enhance its attractiveness to non-US customers, the merchant wishes to display prices in currencies other than dollars, for example Pounds Sterling, Euros and Yen. In order to do this, a new version of the class “book” has to be created in which the instances of each “book” comprise a “title” and a “Dollar price”, “Sterling price”, “Euro price” and “Yen price”. New “book” objects are now created (sometimes termed instantiation) in the new version of the class. Thus, the merchant's catalogue comprises objects belonging to the original class and objects belonging to the new class.

In current systems a new class version may be created by using the inheritance feature of object-oriented languages such as JAVA or C++. A class that requires changes is inherited by a new class that supports new fields and methods without changing the old class. Using inheritance it is only possible to add fields and methods to create new classes. It is not possible to remove fields and methods from inherited classes. An inherited class must have at least the fields and methods of the class from which it is inherited. However, it is possible to create a null method if a method is to be overloaded or suppressed. Thus, class version management using inheritance is restricted in that it can only support additions to classes rather than full re-factoring. Class version management based on inheritance requires a naming/numbering scheme for the new classes because different versions of the same class (i.e. inherited classes) cannot have the same name. This leads to a large number of differently named classes.

Taking the greengrocer Stock Control System as an example, the class Fruit would have to have a series of names as it was added to over time e.g. Fruit, Fruit1, Fruit2 etc.

In the mail order book service each new version of a class such as “Book” has to be given a new name otherwise there will be a conflict between the different versions if they have the same name. In the foregoing example, the new class “Book” would inherit from the class of Book and have all the attributes of that class (e.g. “Title” and “Dollar price”) but also extend it to have the further attributes of a “Sterling price”, “Euro price” and “Yen price”. The new class would also have to have a new name, to avoid name conflict with the original “Book” class. For example, the new class could be named “International Book” and have the attributes “Dollar price”, “Sterling price”, “Euro price” and “Yen price”.

Optionally, an entirely new class called “International Book” may be created having the attributes of “Title”, “Dollar”, “Sterling”, “Euro” and “Yen” prices.

Whatever, class, inherited or new, having a different name is created.

However, the merchant's existing clients or customers may only have application software capable of utilising objects in the original class. Additionally, new customers would not wish to have two types of software, one capable of reading the original class version objects and the other capable of reading the new class version objects, but would only wish to have one form of software. Consequently, the merchant would have to create a catalogue in which the stock (books) are represented by objects in both the original version class and the new version class, in order to provide a service for customers using the original service and those using the new version of the service. For a merchant who wishes to continually maintain, improve and evolve his service, a commensurate evolution and creation of new class versions is necessary. This need to create and store multiple copies of objects to take account of multiple class versions leads to difficulties in maintaining a coherent and integrated service by the merchant. For example, a structured and integrated logical architecture is difficult to maintain for such an evolving service, and the coherence and structure will typically degrade with the evolution. Evolution of such a service requires significant maintenance and re-engineering effort for example, leading to service and system downtime, increased costs for the merchant and also a degraded logical architecture. Furthermore, a duplication of storage capacity is required. For each new version, a geometric increase in storage capacity is necessary, such that for n class versions the storage capacity is increased by a factor 2ⁿ⁻¹ compared to the storage capacity necessary for a single class version. Such a geometric increase in storage capacity is a disadvantage.

Optionally, the merchant could upgrade the service to handle just the most up-to-date class version, which would include ensuring existing customers were provided with suitable upgrade application software. This would involve systems and service downtime for upgrading the service and also leads to problems in maintaining coherence in stock between different class version services. There are also logistical problems in supplying customers with the most up-to-date software. This is also contrary to the desire to provide an “open” as possible service, for which customers do not need to be periodically upgraded. Existing clients may also be resistant to having to upgrade their software in order to use the updated class, particularly if they do not need the enhancements of that class, for example further currencies.

Although an inherited class is often referred to in prior art literature as a new version of the class from which it inherits, this is a technically inaccurate description and the new class is better described as a child or sub-class as it is an extension of the class from which it inherits.

In the following description, aspects and embodiments of the invention will be described using the term “class version”. In this description, the term “class version” or “versions of class” refers to a class which has the same name as another class, but a different structure, i.e. fewer, more and/or different fields, methods and other attributes. The use of the term “class version” and similar terms when describing aspects of the invention, denotes a different sort of class, i.e. not inherited, to that referred to in the prior art using those terms.

Embodiments in accordance with the present invention seek to address at least one of the above-mentioned problems or drawbacks.

Particular and preferred aspects of the invention are set out in the accompanying independent claims. Combinations of features from the dependent and/or independent claims may be combined as appropriate and not merely as set out in the claims.

In accordance with a first aspect of the invention, there is provided a method of operating a data processing apparatus to provide an object-oriented execution environment operable for first and second versions of the same class, said method comprising:

configuring said object-oriented execution environment to communicate with first and second services, said first service operative in accordance with said first version of the same class and said second service operative in accordance with said second version of the same class; and

further configuring said object-oriented execution environment to permit said first service to communicate only with a first version execution environment operative in accordance with said first version of the same class, and to permit said second service to communicate only with a second version execution environment operative in accordance with said second version of the same class.

In accordance with a second aspect of the present invention, there is provided data processing apparatus for providing an object-oriented execution environment operable for first and second versions of the same class, said data processing apparatus configured to:

communicate with first and second services, said first service operative in accordance with said first version of the same class and said second service operative in accordance with said second version of the same class;

to permit said first service to communicate only with a first version execution environment operative in accordance with said first version of the same class; and

to permit said second service to communicate only with a second version execution environment operative in accordance with said second version of the same class.

In a preferred embodiment, the object-oriented execution environment comprises a virtual machine. Embodiments in accordance with the invention support the existence of execution environments for different versions of a class, each version having the same name, in the same virtual machine.

An advantage of an embodiment in accordance with the first and second aspects of the invention is that different versions of a class, having the same class name, may be simultaneously manipulated within the same environment, particularly the same virtual machine, without name space collision which would prevent the simultaneous existence of different versions of the same named class. The first and second version execution environments act to isolate objects of first and second versions of the same class from each other.

This is useful since it becomes unnecessary to update client software for each new versions of a service. Objects from the different versions of a service used by clients can be manipulated within the same virtual machine.

Preferably, the object-oriented execution environment permits a third service operative in accordance with the first version of the same class to communicate only with the first version execution environment. Thus, more than one service can be provided for each class version. This is particularly useful in an internet based environment, in which a number of services of the same version may be required to be present or accessible by clients in order to provide prompt response. Furthermore, it provides for enhanced scalability since all that is required to increase the number of users or clients of a particular version is to begin a new service working with that version.

Suitably, the object-oriented execution environment instantiates a first class context object including a first version class loader corresponding to the first version of the same class for establishing the first version execution environment, and instantiates a second class context object including a second version to class loader corresponding to the second version of the same class for establishing the second version execution environment. Suitably, the first versioned class loader comprises a method for implementing the first version of the same class to establish the first version execution environment, and the second versioned class loader comprises a method for implementing the second version of the same class to establish the second version execution environment. Each of the first versioned class loader and second versioned class loader including a method for establishing an entry interface for respective first and second versions of the same class.

The first and second versioned class loaders are operable to configure respective first and second version execution environments to implement respective first and second versioned object input streams. The first versioned object input stream is operable to receive a bit stream representative of a corresponding object in accordance with the first version of the same class and to output an object of the first version of the same class. The second version object input stream is operable to receive a bit stream representative of an object in accordance with the second version of the same class and to output a corresponding object of the second version of the same class. Such a configuration provides a relatively straightforward implementation of converting a bit stream to an associated object. Furthermore, it provides for data to be supplied to the object-oriented execution environment in bit stream form, which is in a class neutral form, and therefore does not create a name space collision. It is only when the bit stream enters the associated first or second version execution environment is it converted into an appropriate object by the relevant versioned object input stream.

Suitably, the object-oriented execution environment keeps a record of the first and second version execution environments operable for the object-oriented execution environment itself. A service call on the object-oriented execution environment is checked against the record to determine which of the first or second services is making the call and to arrange for communication between a service originating the service call and one of the first or second version execution environments in accordance with the results of that check. Thus, it is possible to ensure that communication can only take place between a service and execution environment operable for the same class version, i.e. the first or second version.

In a particularly advantageous embodiment, the object-oriented execution environment loads the first versioned class loader in response to a service class from the first service. Thus, it is unnecessary to have all the versioned class loaders operable from the outset. They need only be loaded as and when a request for that version of service is made. In a particular implementation, a version class context object includes as one of its attributes a versioned class loader. In such implementation, it is the version class context associated with the version of the service call that is loaded, thereby automatically loading the corresponding versioned class loader.

Correspondingly, the object-oriented execution environment can load the second version class loader responsive to a service call from a second service, or optionally a version class context for the second version of the class.

In a particularly advantageous embodiment, the object-oriented execution environment provides first and second connection points. The first connection point is arranged to permit communication between the first service and the first version execution environment, and the second connection point is arranged to permit communication between the second service and the second service version execution environment. In this way, communications incidents at any particular first or second connection point, can only go to a corresponding first or second version execution environment. Thus, name space collisions are inhibited since an object of the first version cannot be communicated to the second version execution environment, and vice versa.

Suitably, the object-oriented execution environment provides a third connection point corresponding to a third service. The third connection point is arranged to permit the communication between the third service and the first version execution environment. Thus, different services running the same version are restricted as to which execution environment they can communicate with, by first coupling them to a connection point, that connection point only being capable of communicating with the appropriate version execution environment.

The first service is configured to communicate with only the first connection point of the first and second connection points, and the second service is configured to communicate with only the second connection point of the first and second connection points. Furthermore, the third service is configured to communicate with only the third connection point of the first, second and third connection points.

Suitably, the service call from a service to the object-oriented execution environment includes a class version identifier. For such a configuration, the object-oriented execution environment determines which first or second version of the same class the service call relates by inspecting the class version identifier associated with the service call. This is a particularly straightforward way of determining the class version associated with a service call in order to determine which of the version execution environments, or connection points the service call should be directed to.

Suitably, the object-oriented execution environment to form the class version identifier from a hash of the byte code defining a corresponding version of the same class. Typically, the versioned object output stream, or one of its parent classes, includes a method for performing the hash of the byte code to form the class version identifier.

In a preferred embodiment, the first and second version class loaders are operable to configure the first and second version execution environments through a class structure from an object instantiated in respective first or second version execution environments to form a class version neutral object Furthermore, they are configured to associate an object identifier and a class version identifier with the class version neutral object. Preferably, the first and second version class loaders configure respective first and second execution environments to associate a class identifier for the class version neutral object.

Thus, an object instantiated within a particular version execution environment can be converted into a class version neutral form. Such a form can be communicated outside of the version execution environment without causing any name space collisions. The class version neutral object includes an object identifier such that it can be determined as to what that class version neutral object relates, and a class version identifier to indicate from which class version it was formed. Preferably, a class identifier is also included in the class version neutral object, in order to indicate which class it was formed from. This is particularly useful in an environment in which there are different versions of more than one class.

Suitably, the first and second version execution environments are configured to remove class structure to form the class version neutral object by forming a bit or byte stream representative of the object.

In a particularly suitable embodiment, first and second versioned object input streams are implemented by respective first and second version class loaders. The first version object output stream is operable to receive an object of the first version of the same class and to output a bit stream representative of the object and a first version identifier. The second version object output stream is operable to receive an object of the second version of the same class and to output a bit stream representative of that object and a second version identifier.

Suitably, the class version identifier is included in the bit or byte stream. Typically, the class version neutral object comprises an object identifier field, a class version identifier field and a field including the bit or byte stream. Preferably, the class version neutral object further comprises a class name field indicative of the class of the object.

In particularly preferred embodiment, the class version neutral object may be stored. Suitably, an index key is associated with the class version neutral object indicative of the contents thereof, in order to facilitate the structured storage and retrieval of the class version neutral object.

In a particularly advantageous embodiment in accordance with the present invention, a class version neutral object may be retrieved from storage and converted into a different class version object corresponding to a different class version to that class version from which the class version neutral object was formed. For example, a class version neutral formed from a first version object may be retrieved from storage and converted to an object in accordance with the second version. This is particularly advantageous since it means that different versions of a service may retrieve class version neutral objects originating from many different class versions, yet convert them to an object of the requesting version. Thus, it is unnecessary to repeat stored data in each version of a class for which an application service exists since different versions can share data or information between them, and which was formed or originated from different versions. Thus, it is easier to manage the data and control it.

Typically, the conversion comprises populating a field of the different class version object with data from a corresponding field derived from the class version neutral object in accordance with the object identifier and a class version identifier associated with the class version neutral object. Preferably, a field of the different class version object having no corresponding field in the class version neutral object is populated with a default value. Thus, different versions of a class may be created, even though there may not be any corresponding data for all the fields of that class.

In a preferred embodiment of the invention, the first and second version object input streams are operable to recognise a version identifier in an input bit or byte stream. The embodiment comprises receiving a request from a first service to retrieve a stored object corresponding to an object identifier included in the request; communicating the request to the first version execution environment; retrieving a stored class version neutral object corresponding to the object identifier and placing it in the first version execution environment; inputting the retrieved class version neutral object to the first version object input stream and identifying the class version associated therewith as the second version of the same class; and converting the class version neutral object into an object in accordance with the first version.

Suitably the first versioned object input stream instantiates and populates the fields of an object of the first version of the same class with data corresponding to data held in corresponding fields of the retrieved class version neutral object as identified in accordance with the class version identifier. Suitably, fields of the object of the first version of the same class for which the retrieved class version neutral object has no corresponding field are populated with an old data.

Preferably, the object converted to the first version from the retrieved class version neutral object is input to the first version object output stream to form a class version neutral object comprising a bit or byte stream representative of the first version object. The class version neutral object is then stored. Thus, it is possible to convert a retrieved class version neutral object originating from one version, into a class version neutral object originating from another, preferably newer, class version. In this way, class version neutral objects created in accordance with older versions of a class may be gradually updated to newer versions of the class as they are retrieved, and subsequently re-stored. In this way, the stored data is gradually updated to the latest version of the class.

In accordance with a third aspect of the present invention, there is provided a method for configuring a data processing apparatus for processing a class typed object in accordance with a class type version structure, comprising:

configuring said data processing apparatus with a versioned class loader for loading said class type version to provide a class type version execution environment;

providing said class type version execution environment corresponding to said class typed object;

receiving said class typed object;

removing class type structure from said class typed object to form an object independent of said class type version; and

associating a class typed object identifier and a class type version identifier with said class type version independent object.

In accordance with a fourth aspect of the present invention, there is provided a data processing apparatus for processing a class typed object in accordance with a class type version structure, configured to:

include a versioned class loader for loading said class type version to provide a class type version execution environment;

provide said class type version execution environment corresponding to said class typed object;

receive said class typed object;

remove class type structure from said class typed object to form an object independent of said class type version; and

associate a class typed object identifier and a class type version identifier with said class type version independent object.

Preferably, the class type version execution environment compromises a virtual machine.

In accordance with a fifth aspect of the present invention, there is provided a computer system network, comprising:

data processing apparatus substantially as described above for providing a server computer system; and

a client computer system operable to communicate with said server computer system;

said client computer system comprising means for establishing communication with said server computer system for operation in a class type version defined by said client computer system.

An advantage of an embodiment in accordance with the foregoing aspects of the invention is that an overall processing environment insensitive to class version or class type, in particular to the class type version, of an object is created. The class type version independent object is neutral to class version or class type and is not constrained by the class or class type version of the object which it represents. It can therefore be manipulated independently of such constraints, since it is independently operable from the general object-oriented or class type execution environment. Thus, objects of the same class, yet different versions, may be converted into class version independent objects and manipulated within the same processing environment. Creating such a general or overall class or class type version insensitive environment is contrary to conventional programming using programming languages such as object-oriented languages having strict data entity structure or class rules. Indeed, it is inconsistent with the general aim of such object-oriented languages.

Nevertheless, the applicant has recognised that the foregoing aspects of the invention provide significant advantages in that services which utilise different class or class type versions may use a common processing environment. This is particularly advantageous when a service evolves or is updated. In accordance with aspects of the present invention, it is no longer necessary to create data entities in all the different versions of the service that may be run, or alternately update all the data entities into the current version, but handle them all in the class or class type version insensitive environment. This substantially reduces the significant maintenance and update activities which would otherwise have to be undertaken by an operator of the service. It also reduces the possibility of lack of coherence between data entities converted between versions, which is likely to occur if such conversions are necessary. Furthermore, the logical architecture of the system may be maintained, even though different versions of a service have been created and are being used.

A further advantage of embodiments of the invention in accordance with the foregoing aspects is that new versions of a service may be implemented without any need to update version handling of the data processing apparatus. All that is required is that the appropriate class version is loaded into the data processing apparatus according to the version of the service which wishes to utilise the data processing apparatus.

Thus, even if a new version of the service is created, it is not necessary to update the data processing apparatus, for example start a new virtual machine to handle that version of the service. The data processing apparatus can be configured to provide the appropriate class version execution environment corresponding to the new version. This may be done automatically, in that the appropriate class version execution environment can be ready for implementation before an object of the new version is sent to the data processing apparatus, and the appropriate class version execution environment automatically established on receipt of that object. This is a significant advantage in reducing the amount of maintenance required for the data processing apparatus.

Preferably, a class identifier is associated with the class independent object, which ensures that the class type of the object represented by the class independent object may be determined. Thus, even though the class independent object may be manipulated without the constraints of the class of the object which it represents, nevertheless information about that class is obtained.

Suitably, class type structure is removed from the class type object by forming a bit r byte stream representative of the class type object. Optionally, a representation of the lass type version identifier may be included in the bit or byte stream.

Preferably, the class type independent object comprises an object identifier field, a class version identifier field and a field including the bit or byte stream, thereby forming a class type independent object.

Preferably, the class type independent object comprises a class name field indicative of the class type of the class type independent object which is useful for sorting class independent objects by class name.

In a sixth aspect of the invention, the class type independent object may be stored, in suitable storage medium. For an object-oriented environment, such a storage medium effects a so-called Object Space, termed a persistent Object Space where a non-volatile storage medium is used and a transient Object Space where a volatile storage medium is used. Preferably, an index key is associated or stored with the class type independent object, which is indicative of the contents of the class typed object represented by the class type independent object. This provides a useful means for sorting and retrieving class typed objects which are represented by class type independent objects.

In accordance with a seventh aspect of the invention, an execution environment corresponding to a different class type version is provided and the class type independent object is converted into a different class type object corresponding to the different class type version. Thus, a later version of a service may utilise objects created under a previous or different version of the service by converting their class type independent object form into a class typed object corresponding to the later or different version of service. Suitably, the data process apparatus is configured with a versioned class loader for loading the different class type version for providing the different class type version execution environment.

In a preferred embodiment in accordance with the invention, fields of the different class typed object are populated with data from corresponding fields of the class typed object derived from the bit or byte stream in accordance with the object identifier and version identifier associated with the class type independent object. That is to say, knowledge of the object and version of the object represented by the class type independent object are used to map the contents of the relevant fields into the corresponding fields of an object within a later class type version. Since the contents of the fields are derived from the bit or byte stream, there is no class type structure, since they are at the lowest level of representation for the data processing apparatus has been used. Therefore, the contents may be entered into the appropriate fields for the later version objects. In a preferred embodiment of the invention, the conversion process comprises populating a field of the different class typed object having no corresponding field in the class type object with a default value derived from the different class type version context. For example, where it is known that the contents of the additional field in the new version object has a standard entry, for example an international dialling code “44” for a telephone directory service, then that standard content may be entered into the additional field. Thus, objects created under previous class versions may be up-dated such that they comprise the information used in a later or different class type version.

In a particular aspect of the invention, a request for retrieving a stored object is received in accordance with a different class type version. The stored class type independent object corresponding to the object to be retrieved is identified and then converted into the different class type object. Thus, a version of service within the a different class type version may request retrieval of a stored object stored in accordance with the class type version, identify a stored class type independent object corresponding to the object to be retrieved and convert the class type independent object into the different class type object. Suitably, the different class type object may have its class type structure removed to form another object independent of class type. The object identifier and the different class type version identifier are then associated with the another object independent of class type for replacing the class type independent object. Thus, it is possible to update previously stored objects, such that they are now stored in a class type independent form, yet representing an up-dated version of the class type. Thus, the stored objects may be considered to evolve along with the evolution of the different versions of service. However, such evolution need only take place when a previously stored object is accessed by a later class type version.

Optionally, the updating and evolution of previously stored objects may be automated for each new version of service, thereby automatically maintaining the data processing apparatus in accordance with the most recent version of service. Such automatic up-dating would reduce the likelihood of errors occurring for such updates and will also maintain a logical architecture of the system throughout the various versions of service with which it has to operate.

The another class type independent object is typically stored for later retrieval.

In accordance with another aspect of the invention, there is provided a computer program comprising computer program means for configuring a data process apparatus to implement embodiments of the invention as described in the foregoing paragraphs. Suitably, the computer program comprises so-called source code, object code or interpreted code. As will be evident to a person of ordinary skill in the art, source code will have to be compiled on the target data processing apparatus before it can be run and cause the processing apparatus to operate in accordance with the source code. Optionally, object code, that is to say compiled code, may be provided to the target data processing apparatus, which may be run by the processing apparatus substantially as received.

In a further aspect of the invention, there is provided a carrier medium for the previously described computer program. The carrier medium may comprise a magnetic storage medium such as a tape or disc storage medium, an optical storage medium such as a read/write, CD-ROM or solid-state memory. Such storage media may be delivered to a user for loading onto a suitable data processing apparatus. Optionally, the carrier medium may comprise a telecommunications carrier medium, the computer program being embodied as an electronic or electrical signal carried by the telecommunications signal. Such a carrier medium may be an RF carrier signal, an optical carrier signal for an electronic carrier signal.

In a yet further aspect of the invention, there is provided a computer system network, comprising data processing apparatus substantially in accordance with the data apparatus described in the foregoing paragraphs. The computer system network also comprises a client computer system which is operable to communicate with the server system. The client computer system comprises means for establishing communication with the server computer system for operation in a class or class version defined by the client computer system. Thus, a client computer system may use whatever version of service has been made available to it. For example, some clients may wish to use an older version of service whilst others may wish to use a later version of service. The server computer system may be responsible to a communication with a client computer system to load a class or class type version corresponding to the class or class type version utilised by the client computer system. Thus, the class type version under which the server computer system operates is defined and is dependent upon the class type version of the service utilised by the client computer system.

Thus, the server computer system does not need to be configured to run in any particular version of service, but may be arranged to respond to client computer systems to configure itself to operate in accordance with the version of service used by that client computer system. This provides for a highly adaptable, modifiable and scalable computer system.

Suitably, the server computer system loads the class or class type version corresponding to that used by the client computer system from a class or class type storage medium. Such a storage medium may be a part of the server computer system, or, where the computer system network is operable for the Internet, the storage medium may correspond to a URL communicated to the server from the client. Thus, the client computer system informs the server computer system of the location of the class or class type version used by the client which in an Internet configuration may be a URL. The server computer system then accesses the URL communicated to it and loads the class version stored thereon.

Having a distributed storage for class versions again provides for a scalable system, which may be easily modified and updated. Furthermore, it provides for a highly structured and manageable architecture.

An advantage of an embodiment of the invention is that representations of class typed objects may be stored in non-class structured storage environments, yet still be identified as belonging within a class version. Thus, it is possible to effectively store objects having different class type versions in the same storage environment, by way of their being stored in class independent or insensitive form. Thus, it is unnecessary for the storage environment to handle different class versions, and there is no need to load different classes into the storage environment in order to process objects within different class versions. Furthermore, a class independent or insensitive environment may be created in which representations of class typed objects in different class versions can be manipulated in accordance with an application program, for example.

Another advantage of embodiments in accordance with the invention is that an object within a class type version may be stored in such a way that it may be retrieved in a different class type version. A requestor of a stored object may be operating within a class type version different to that in which the stored object was created, yet still access and retrieve that stored object. Thus, it is unnecessary to store multiple class type versions of an object in order to allow requesters operating within different class type versions to retrieve the object.

Specific embodiments in accordance with the present invention will now be described, by way of example only, with reference to the drawings, in which:—

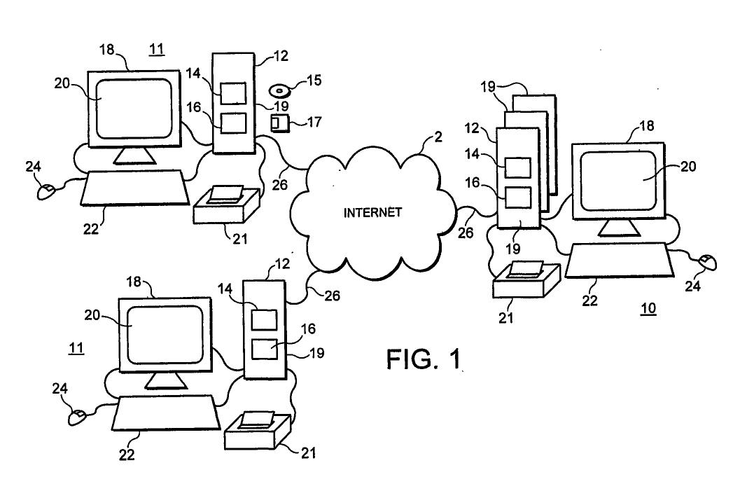

FIG. 1 is a schematic illustration of a computer network comprising server and client computer systems;

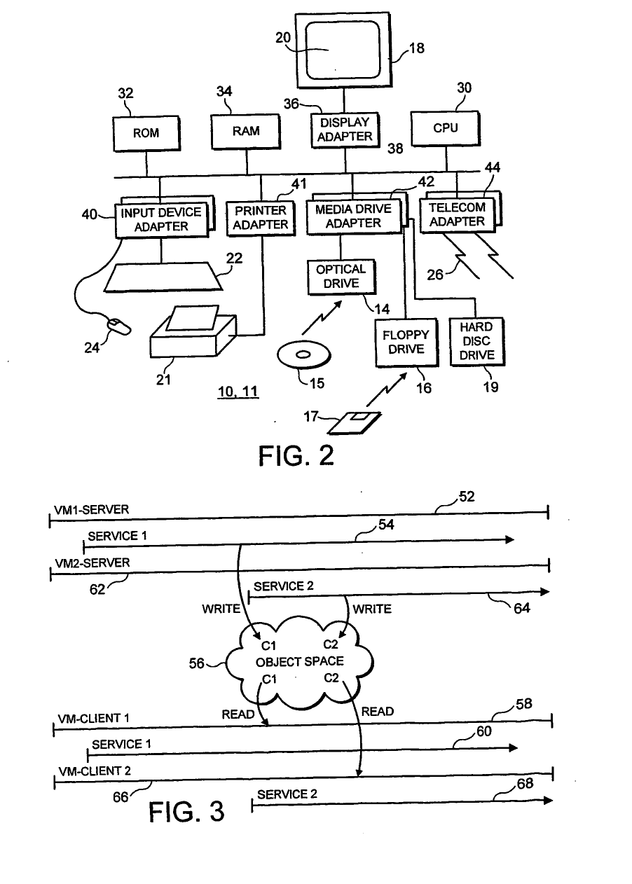

FIG. 2 is a block diagram illustrating the components of a computer system of FIG. 1;

FIG. 3 is a diagrammatic illustration of a multi-versioned class environment in accordance with the prior art;

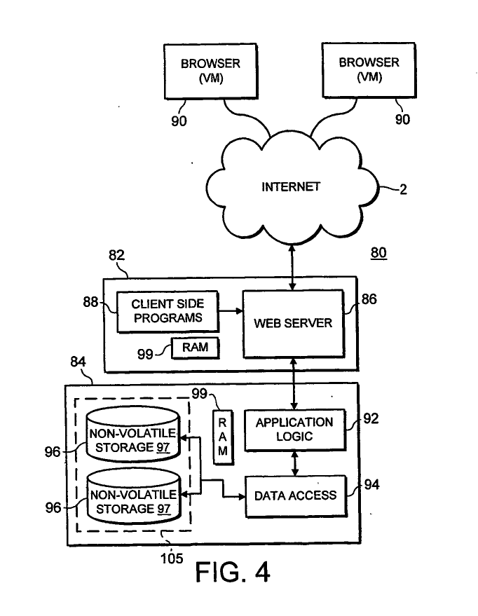

FIG. 4 schematically illustrates the logical system level architecture for an embodiment of the invention;

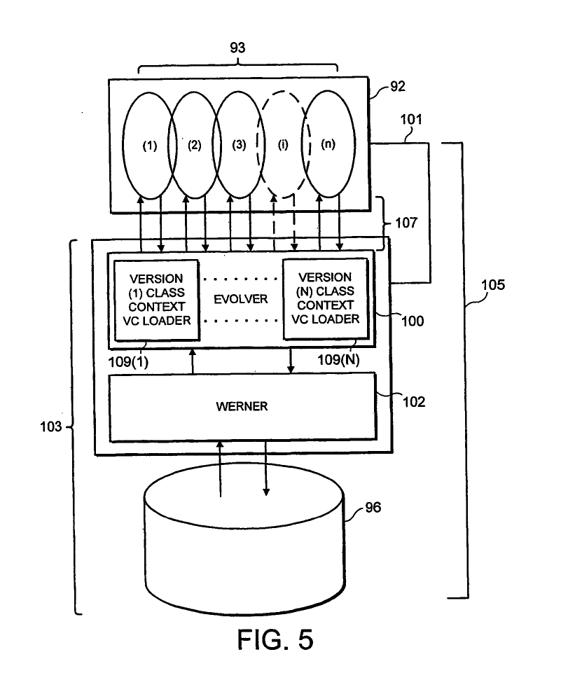

FIG. 5 schematically illustrates the logical server architecture for an embodiment of the invention;

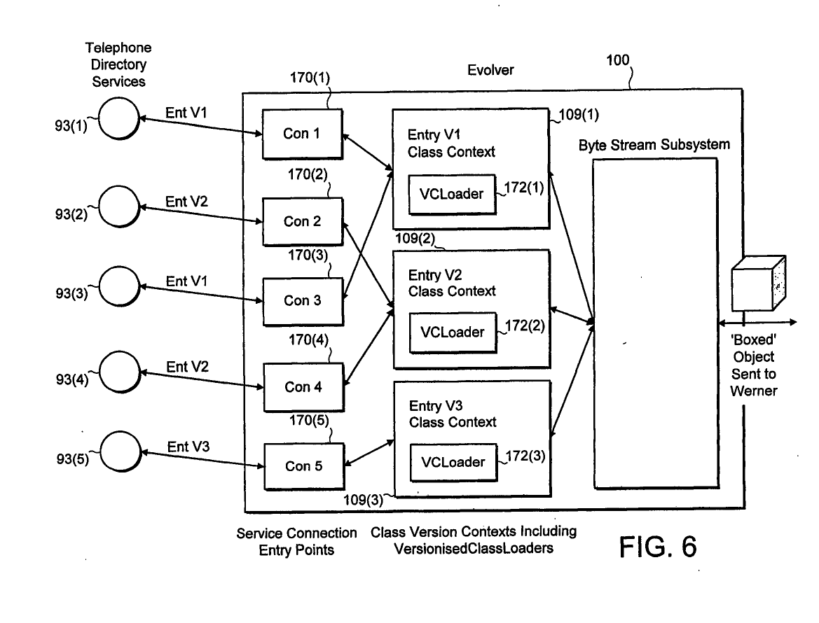

FIG. 6 schematically illustrates the configuration of an embodiment of the invention for operating on different versions of the same class in the same virtual machine;

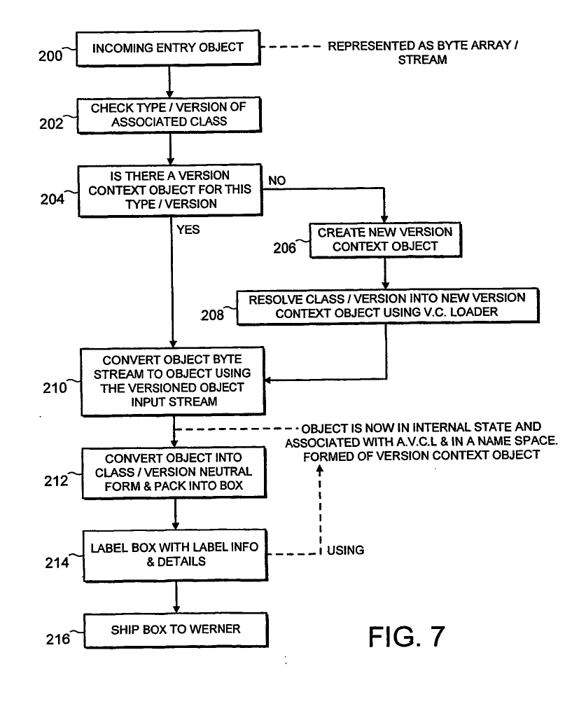

FIG. 7 is a flow diagram illustrating the setting up of the configuration of FIG. 6, and the operation of an embodiment of the present invention;

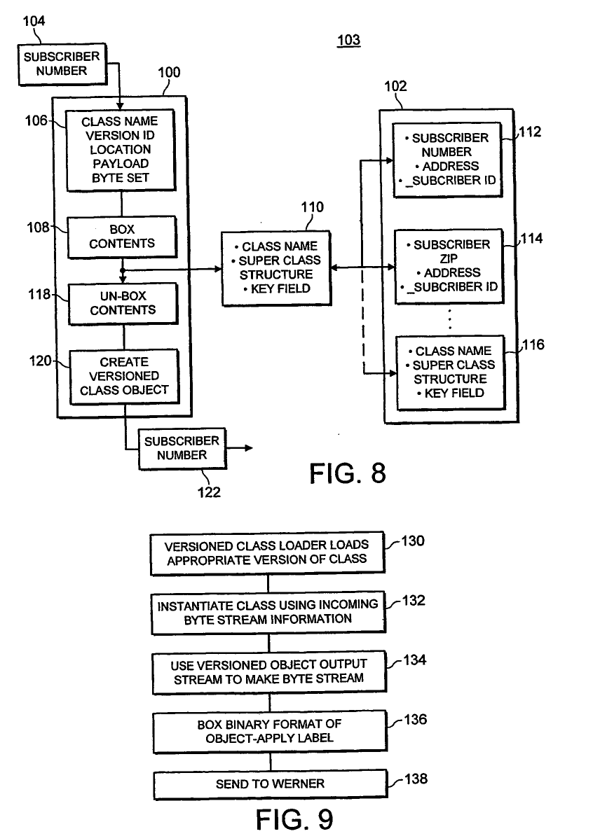

FIG. 8 schematically illustrates the functional architecture of an embodiment of the invention;

FIG. 9 is a flow diagram illustrating the formation of a class neutral object in accordance with an embodiment of the invention;

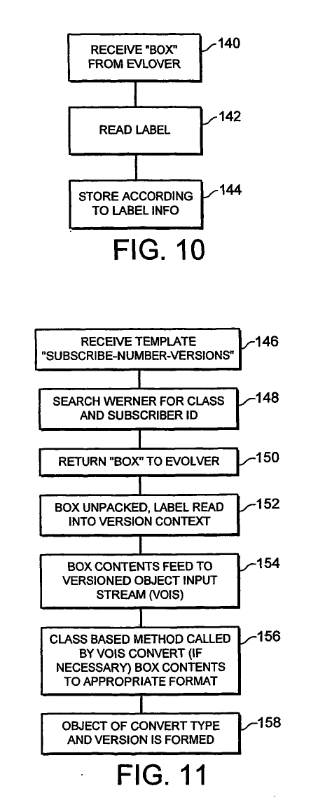

FIG. 10 is a flow diagram illustrating storage of an object in accordance with an embodiment of the invention; and

FIG. 11 is a flow diagram illustrating retrieval of a stored object in accordance with an embodiment of the invention.

A suitable environment for embodiments in accordance with the present invention is a network environment. By way of introduction, there now follows a general description of examples of network environments.

To enhance their functionality and to share resources, for example printers, scanners, etc, individual computer systems are often linked together to form computer networks. Such networks may be limited to individual organisations and even to discrete geographic locations for that organisation. For example, a particular building or even floor within a building. However, some computer networks comprise computer systems which are geographically located at a distance from each other, even in other countries, for example. Often, such large area networks are not limited to individual organisations, but link computer networks of different organisations so that a large area network of computer networks is formed.

A particularly important example of such a network of networks is the Internet. The Internet comprises a network of computer systems and computer system networks spanning substantially the whole of the developed world. No one organisation owns or is responsible for the Internet as a whole. The computer systems and computer networks linked together by the Internet may be owned and operated by different organisations. Each computer system within the Internet has a unique address and can communicate with other computer systems within the Internet by using the other system's address. The format for communication between computer systems on the Internet is defined by the Internet Protocol (IP), in order to ensure that all the systems on the Internet can understand and communicate with each other. The telecommunication systems utilised by the Internet may comprise ISDN services, Plain Old Telephone Systems (POTS), Digital Subscriber Line (DSL), mobile or wireless communication systems such as cellular or satellite radio telephone systems, cable communication or other suitable telecommunications medium.

A particularly useful piece of software for computer networks is something known as the World Wide Web (WWW). The WWW is most often used with the Internet, which fully utilises its functionality, but the software may also be used with other networks.

The term WWW is also used to refer to the body of information embodied in different media such as text, audio or video, for example, and stored on computer systems within the computer network, such as may form part of the Internet. The information is divided up into suitable segments, typically relating to the nature of the information, for example, an image may be formed as a graphics file, and a document as a text file. Additionally, such information may also comprise so-called Web pages which are datafiles comprising information, which may be of different types, and instructions on how to format that information when it is displayed on a computer screen. Within the WWW, not only do individual computer systems have addresses, but individual pieces or groups of information. Thus, by setting the correct address, it is possible from one computer system to communicate with not just another computer system, but to access a particular piece of information stored on that computer system.

The Internet and WWW have been utilised by many commercial organisations in order to provide an alternative route for provision of their goods and services to that offered by the conventional trading or retail outlets. Such organisations make it possible to purchase goods and services over the Internet, for example books from the virtual bookshop at WWW.AMAZON.COM. Virtual stores such as AMAZON.COM operate substantially as conventional retailers but use a location on the Internet or WWW, known as a web site, to allow potential customers and purchasers access to the goods and services instead of via a conventional store.

Referring now to FIG. 1, there is illustrated a schematic representation of a network of computer systems, such as the Internet, comprising a server computer system 10 and client computer systems 11. Both the server computer system 10 and the client computer systems 11 comprise similar components, for example a system unit 12, a display device 18 with a display screen 20, and user input devices, including a keyboard 22 and a mouse 24. A printer 21 is also connected to the system. Each system unit 12 comprises media drives, including an optical disk drive 14, a floppy disk drive 16 and an internal hard disk drive not explicitly shown in FIG. 1. A CD-ROM 15 and a floppy disk 17 are also illustrated. Additionally, server computer system 10 comprises high capacity storage media, such as further magnetic hard disks 19, for example.

A computer program for implementing various functions or conveying various information may be supplied on media such as one or more CD-ROMs and/or floppy disks and then stored on a hard disk, for example. The computer system shown in FIG. 1 is also connected 26 to a network 2, which in the illustrated embodiment is the Internet but may be a local or wide area dedicated or private network, for example. A program implementable by a computer system may also be supplied on a telecommunications medium, for example over a telecommunications network and/or the Internet, and embodied as an electronic signal. For a client computer system 11 operating as a mobile terminal over a radio telephone network, the telecommunications medium may be a radio frequency carrier wave carrying suitably encoded signals representing the computer program and data or information. Optionally, the carrier wave may be an optical carrier wave for an optical fibre link or any other suitable carrier medium for a land line link telecommunication system.

Referring now to FIG. 2, there is shown a schematic and simplified representation of an illustrative implementation of a data processing apparatus in the form of a computer system such as that referred to with reference to FIG. 1. As shown in FIG. 2, the computer system comprises various data processing resources such as a processor (CPU) 30 coupled to a bus structure 38. Also connected to the bus structure 38 are further data processing resources such as read only memory 32 and random access memory 34. A display adapter 36 connects a display device 18 to the bus structure 38. One or more user-input device adapters 40 connect the user-input devices, including the keyboard 22 and mouse 24 to the bus structure 38. An adapter 41 for the connection of the printer 21 may also be provided. One or more media drive adapters 42 can be provided for connecting the media drives, for example the optical disk drive 14, the floppy disk drive 16 and hard disk drive 19, to the bus structure 38. One or more telecommunications adapters 44 can be provided thereby providing processing resource interface means for connecting the computer system to one or more networks or to other computer systems. The communications adapters 44 could include a local area network adapter, a modem and/or ISDN terminal adapter, or serial or parallel port adapter etc, as required.

It will be appreciated that FIG. 2 is a schematic representation of one possible implementation of a computer system, suitable for either a server computer system 10 or a client computer system 11. It will be appreciated, from the following description of embodiments of the present invention, that the computer system in which the invention could be implemented, may take many forms. For example, rather than the server computer system 10 comprising a display device 18 and printer 21, it may be merely necessary for the server computer system 10 to comprise a processing unit, and be accessible by client computer systems 11. The client computer may also be a non-PC type of computer which is Internet- or network-compatible, for example a Web TV, or set-top box for a domestic TV capable of providing access to a computer network such as the Internet.

Optionally, the client computer may be in the form of a wireless PDA or a multimedia terminal.

Each computer system 10, 11 has a unique address within the Internet and within the terminology of the WWW these addresses are known as Uniform Resource Locators (URLs). Additionally, each entity within the WWW may also have a unique address or URL. An entity may comprise many different types of information, for example text, graphics, audio, video etc and may therefore be referred to as a hypermedia document or entity. Files comprising a single data type such as a graphics file, audio file, video file, etc may also be found on the WWW, and are individually addressable. Within the WWW, hypermedia entities are created and handled using a programming language called Hypertext Markup Language (HTML). HTML provides a method of formatting entities by which the information content may be separated from the presentation of the entity. Elements of a page are associated with tags which are format codes. That is to say entities containing the same information may be presented in different ways. HTML is a particular example of a Markup language which uses only predefined tags to format or describe elements of a page. A more flexible language is a language known as EXtensible Markup Language (XML) which allows tags to be defined by the developer of the page. Other examples of Markup languages are Wireless Markup Language (WML) for wireless Internet access applications operating in accordance with the Wireless Application Protocol(WAP), and Financial Markup Language (FML), particularly designed for formatting financial information.

WWW software is based on client-server architecture. A web client, for example a browser, is a computer program which can send requests for information such as documents, to a web server. A web server is a program which, in response to a request from a client, sends documents (entities), or error messages if appropriate, requested by the requesting client. The web server resides on a server computer system 10. The entity received by the client is stored on a client computer system 11, typically on hard disc drive 19 in a process known as “caching”. The client programme typically resides on hard disc drive 19 of the client computer system 11 and is operable to configure client computer system 11 to interface with the Internet and WWW.

An embodiment of the present invention may be implemented in an object-oriented language such as the JAVA programming language. A brief description of JAVA will now be provided as an example of an object-oriented language. JAVA is predominantly implemented as an interpreted language that uses an intermediate language (byte code). The source code of a JAVA program is compiled into byte code which cannot be run by itself. A JAVA interpreter known as a JAVA Virtual Machine (JVM), implements the byte code to configure and control the computer upon which the JVM is runrnng. The JVM operates as a software implementation of a processor which understands byte code. In this respect, the JVM can be regarded as emulating a JAVA chip. Different JAVA interpreters, or JVMs, may be designed for different computer systems from different manufacturers, which results in JAVA programs being independent of the hardware platform upon which they are run. By use of an appropriate JVM, a JAVA program may be run on any hardware platform. The platform independence of JAVA has meant that it has found particularly suitable application on the Internet, where users of the Internet may be operating browsers based on many different types of hardware platforms. As will be evident to persons of ordinary skill in the art, JAVA is one example of an object-oriented language utilising a virtual machine. Another example is Smalltalk which utilises Smalltalk Virtual Machines (SVM). Further, it will be evident from the following description that embodiments in accordance with the present invention are not limited to implementations involving virtual machines, but may be applied to other object-oriented languages, and may even be applied to languages which are not object-oriented languages.

By way of introduction, prior art problems will now be explained by way of example, with reference to FIG. 3. The prior art problems are described with reference to class versions, however it should be recalled that the term “version” is used in the prior art to refer to an inherited class, or even to a new class implementing a new or updated object type.

FIG. 3 diagrammatically illustrates the provision of a multiple versioned class service. A merchant runs a Virual Machine (VM) 52 on their server. Typically, the VM will be a software implemented interpreter, but may be implemented in a chip to provide a hardware VM, such as the JAVA Xpresso chip from Zucotto Systems Inc. However, such chip implementations of the VM are more likely to be utilised in a client system, in particular a mobile system such as a wireless device. The merchant runs a first service application 54 on the VM 52, which implements a mail-order catalogue for books, for example. Items for the catalogue are defined by the class “book” and comprise both the title of the book and its dollar price. These book objects are created by instantiating an object of the class “book” and then writing them into an Object Space 56. Entries are made to the Object Space 56 by way of the Object Space's interface. The instantiated object is a parameter of the “write” on the Object Space. An Object Space is a storage area for objects. The Object Space may be persistent, in that it is embodied on non-volatile memory media, or transient, where it is embodied on volatile memory media. Within the Object Space 56, objects are passive. That is to say, they exist but cannot be operated on or utilised. An object has to be read or taken from the Object Space into an appropriate service or application program for example, in order for it to be utilised. The Object Space concept is a particularly useful concept for the design and management of distributed computing or processing architectures, but it will be evident to a person of ordinary skill in the art that the Object Space represents merely one form of storage, and that embodiments of the present invention may utilise other storage means or concepts. A system running JAVA may, for example, store objects in a JAVA space, which is a JAVA specific implementation of an Object Space.

A first client runs a VM 58 on their hardware platform. The first client also runs first service software 60 which is designed to interact with the merchant's mail-order service 54. In this example, it is capable of reading objects from Object Space 56 which have been written thereto by the merchant software 54 in the current version (C1) of the class “book”.

At some time later, the merchant decides to introduce a global service, for which it is necessary to provide prices for the books in currencies other than dollars. For example, Sterling, Euros and Yen. In order to effect this new service, the merchant sets a new mail-order service application 64 running on a new VM 62. The merchant sets up a new virtual machine on their server for running the new service 64 in order to avoid any “name space” collisions with the original service 54, which would occur should both the new and old service be run on the same virtual machine and use the same class name. New service 64 writes objects within the new version class (C2) to Object Space 56. New clients running VM 66 can read objects within the new class C2 from Object Space 56 by virtue of a new service, 68, set up to handle objects of the new class version C2.

In order that clients running service 60 can continue to use the catalogue, together with clients using the new service 68, it is necessary for the merchant to create objects in both the original class C1 and the new class C2, so that both VMs 52 and 62 have access to objects in their respective classes C1 and C2 which represent the merchant's fill inventory. Thus, there would be a need for twice as many storage spaces as there are books in the mail-order catalogue. As described above, storage requirements for the Object Space 56 increases at least linearly and possibly geometrically with each new version of a class in accordance with a factor 2ⁿ⁻¹, where n is a number of class versions. Furthermore, it is difficult to maintain coherence between versions for the stock.

Optionally, the merchant could use an inherited class from C1 to form C2. In this case only, one VM would be necessary but the systems would have to be rewritten.

Optionally, the merchant would have to upgrade the service and existing objects for operation in accordance with new class C2, which would involve undesirable system and service downtime, and translation of C1 objects into C2 objects. Furthermore, existing clients would have to be upgraded to the C2 version.

The logical architecture of an illustrative embodiment of a merchant service operating within an Internet environment will now be described with reference to FIG. 4. The merchant's service resides on one or more server computer systems collectively referenced 80 in FIG. 4. The merchant server 80 comprises a front end 82 and a back end 84. The front end 82 comprises a web server 86 which performs the usual function of a web server, such as handling requests for access to the merchant server, and providing information from the server to a requesting client. Such webservers 86 can be automated by the use of Object-Oriented software such as JAVA servlets that automate the generation of web-based content based on client requests. Client side programs 88 are typically JAVA applets or JAVA script (for a JAVA implemented embodiment) and are stored on a suitable storage medium and can be downloaded to clients' virtual machines to configure them to operate with the merchant's service. The web server 86 typically provides a user interface for accessing the merchant's service. In the example illustrated in FIG. 4, the client side programs are JAVA applets or JAVA scripts, and the clients comprise JAVA virtual machines running within suitable browser software 90, such as Netscape 4.0 on a client computer system 11.

The web server 86 is in communication with the merchant service application logic 92, residing in the back end 84. Such logic may be implemented within an Application Server in the form of Enterprise JAVA Beans, for example. Communication between the front end 82 and back end 84 may be managed by suitable software, such as Message Queuing Service software from IBM, which manages the transfer of messages to and from the back end 84 and front end 82.

Application logic 92 provides the software engine for the merchant service. For example, in an e-commerce service the application logic 92 configures the backend 84 to make a catalogue of goods available to a client, process requests for goods and deal with taking billing details such as credit card details and billing address and delivery address, for example, via the front end 82. The application logic 92 will also need access to stored and/or shared information. Thus, the backend 84 also includes databases 96, typically utilising non-volatile storage media. Databases 96 will store necessary data for the merchant application, for example the catalogue of goods, client's billing details, delivery address details and other suitable data. Communication between the application logic 92 and databases 96 is controlled by data access module 94.

Databases 96 may be configured in any suitable database language, for example they may comprise a relational database utilising Informix or Oracle programming software, or optionally may be Object based databases such as Versant. Preferably, the application logic 92 makes use of Object Spaces for data access using data access module 94. The Object Space may be configured to store information in transient storage media, such as RAM 99, or in persistent (non-volatile) media such as disk drives 96. Implementations of Object Spaces that make use of transient storage media are termed Transient Spaces, and implementations of Object Spaces that make use of persistent storage media are termed Persistent Spaces.

The transient Object Space 101 is typically used during the manipulation of objects as a temporary or “scratch pad” storage area. The persistent Object Space 105 is typically used for longer term storage. The term Object Space without qualification, shall be used to refer to an Object Space in general.

For the persistent Object Space 105, a non-volatile storage technology is necessary. For example, a disk drive storage medium may be used by databases such as database 96. An interface is provided between the persistent Object Space 105 and the physical storage media (e.g. disk drives) by means of a mapping function such as an Object Space abstraction layer between the persistent Object Space and the disk drive. The Object Space abstraction layer merely configures objects for storage on the target storage medium.

In the present example of an embodiment of the invention, the merchant service is a telephone directory service. As is well known, a basic element of object-based systems is the class, which is a software component of an application that holds executable code and data defining a class for that application. The telephone directory service comprises an application component which defines a class “SubscriberNumber”. The subscriber numbers are formed as objects comprising a public character string for the subscriber identity and two private integer numbers, one representing the local number and the other the STD code for that local number. Persistent Object Space 105 is populated with objects having the foregoing attributes, thereby forming a directory of subscribers and corresponding telephone numbers.

Sometime later, requirements for a new version of service dictate that international dialling codes are to be stored and retrieved by the system along with the currently held code. This creates a new class of subscriber number, defined by another application component software, which includes a further integer representing the international dialling code. Furthermore, new features have been added to the new subscriber number class, in that the international dialling code may be requested and provided to the requester.

Conventionally, there will exist two types of object, subscriber number and new subscriber number, for storage in persistent Object Space 105. Furthermore, and subscriber numbers will have to be stored as objects in both classes, in order to provide continuity for users of the system who operate software which merely requires national codes. That is to say, subscriber numbers including the STD number and the local number, and subscribers using the enhanced international service and utilising subscriber numbers including the international dialling code, STD and local number. As discussed above, this leads to a significant increase in memory requirements, or service and object class version upgrades.

A telephone directory service will now be described for an object-oriented environment. An Object Space Entry for the telephone directory service is formed by creating an instance of the class SubscriberNumber (which is the Entry for the object space). The information fields are set by calling various methods on the appropriate class interface, such as setLocalNumber and set STDCode.

The class name is defined as “SubscriberNumber” and defines an Entry in the Object Space which comprises a character string “_SubscriberID” representing a subscriber's alphanumeric identity, for example their name. The “_SubscriberID” field is designated a public field, since it is a key field or index field, capable of being searched by a user of the telephone directory service. There are then defined two integer numbers “_LocalCode” and “_STDCode” respectively representing a local telephone number and its associated STD code. These fields are designated private indicating that they should not be used as key or index fields.

Within the class format, there are further defined operations which may be applied to objects within the SubscriberNumber class. These operations are termed “accessors”. A first operation is an integer operation named “getSTD( )”, which gets the STD code from an entry in the Object Space. Another operation is named “getLocalNumber( )” which gets the local code from the appropriate entry in the Object Space. A further operation is a character string operation and is named “getSubscriberID( )” which gets an entry from Object Space having a subscriber identity corresponding to a searched subscriber identity from the Object Space. Further operations relate to the creation of new entries in the Object Space and comprise the operation “setocalNumber (IntNewNumber)” and “setSubscriberID( )” which respectively create a new local number and a new subscriber ID corresponding to a new subscriber ID which are written to the Object Space.

As can be seen from the foregoing, a subscriber number is stored along with the local and area (STD) code for the subscriber line. This version of the class is termed version 1.

The foregoing class description is compiled by a suitable build system, such as may be found in a Software Development toolkit, when creating the application logic 92 for the telephone directory service. The build system creates the class packaging, naming and location format as defined above and which is understood by the Object Space. Application logic 92 also includes a build system (Build Tools) service for an application designer to create classes, and their associated structure. The Build Tools system configures classes into a class packaging, naming and location format which can be understood by the respective telephone directory services 93. In this respect, it should be noted that the Build Tools System can be utilised to add new telephone directory service versions to application logic 92, as may be required from time to time. The Build Tools are configurable to name or locate; or name and locate various versions of a class or set of classes using a suitable naming and location scheme. In a preferred embodiment of the present invention, running in the JAVA environment, classes are located in a JAVA archive (“Jarfile”) which is located in storage media accessed by a web server. Preferably, the storage media is accessible by web server 86 and forms part of the hardware platform for the telephone directory service. For the “Jarfile” located in storage media accessible by web server 86, a storage location will be defined by a suitable URL (Unique Resource Locator) for identifying the class location on the telephone directory service site. For example, a suitable URL may be “www.intamission.com/classes/systemB2.JAR”, for identifying the version 2 class located on the intamission.com website. Optionally, the “Jarfile” may be located away from the telephone directory site, and accessible via a webserver elsewhere on the Internet. Other locations and access formats may be utilised, but by locating classes under a URL, the classes become available over the Internet via webserver and may be utilised by any suitable communications system having access to the Internet. As will be evident to a person of ordinary skill in the art, a network other than an Internet may be utilised for locating Jarfiles, for example a private or local area network.

Any type of Build Tools system may be used to generate, name, locate and package a class, including command line driven, make file driven or graphics user interface driven build systems.

As is well known in the art, entries are created by instantiating an object of any class that implements an Entry interface for that class, and then performing a “write” operation on the relevant Object Space, supplying the object as the entry parameter. The Entry interface is a part of respective telephone directory services 93 running in application logic 92.

In the case of the present example, the telephone directory service 93(1) first creates an instance of a SubscriberNumber (which is an Entry for the Object Space). The information fields for the instantiated Entry (or object) are set by calling various methods on the class interface, such as setLocalNurnber and setSTDCode.

The Entry interface has the format and structure described in the following pseudo-code, which will be readily understood by persons of ordinary skill in the art as representing a general example of an implementation of the Entry interface.

| | |
|---|---|
| 1. | class SubscriberNumber implements Entry |
| 2. | { |
| 3. | //field is public to show that it is key field |
| 4. | // this key field is the subscriberID |
| 5. | public String_subscriberID; |
| 6. | //these fields are private and contain the phone number in its various |
| 7. | // parts |
| 8. | private int_localCode; |
| 9. | private int_STDCode; |
| 10. | //accessors for private and keyFields |
| 11. | public int getSTD( ); |
| 12. | public void setSTD(int newNumber); |
| 13. | public int getLocalNumber( ); |
| 14. | public void setLocalNumber(int newNumber); |
| 15. | public String getSubscriberID( ); |
| 16. | public void setSubscriberID(String subID); |
| 17. | } |

Referring to the foregoing pseudo-code by line number, line 1 defines a class, SubscriberNumber, which is an Entry for the Object Space. Line 5 defines a character string “_subscriberID” as a key field, by assigning it as a public field. The local code is defined at line 8 as a private field, which cannot be seen outside of the class SubscriberNumber, and therefore cannot be used as a key field. A similar definition for the STD code field occurs at line 9.

Lines 11 and 12 define accessors which notify users of an object of the class that it is possible to get and set the STD code. Similarly, Lines 13 and 14 define accessors which notify users of an object that it is possible to get and set the local code. And lines 15 and 16 define accessors for the subscriberID. Lines beginning with “//” are comment fields, typically included to aid understanding of the pseudo-code.

An Entry of the type SubscriberNumber may now be created, set with appropriate information and written into the Evolvable Object Space 103. An embodiment of the telephone directory service 93(1) has the following pseudo-code format:

| | |
|---|---|
| 1. | // create a new SubscriberNumber |
| 2. | SubscriberNumber subs = new SubscriberNumber( ); |
| 3. | // set the new subscriber information |
| 4. | subs.setSubscriberID(“Jim”); |
| 5. | subs.setLocalCode(123456); |
| 6. | subs.setSTDCode(01789); |
| 7. | //write the entry into the space |
| 8. | objectSpace103.write(subs, null, null); |

Line 2 of the foregoing pseudo-code creates a new Entry (object) of the class SubscriberNumber, in which the object is referred to as “subs”. Lines 4,5 and 6 use the set methods described with reference to the Entry interface pseudo-code, to set the information within the “subs” Entry (object). Line 8 uses a reference to Object Space 103 available to the telephone directory service 93(1) to write the “subs” Entry into the Evolvable Object Space 103. The write method in line 8 includes two further parameters having null values. These parameters relate to features of object-oriented space systems which are unnecessary for describing the working of embodiments of the present invention, and are therefore designated nulls in the foregoing example.

Over time, a new requirement is given by users of the system who wish to make international calls. In order to service this new requirement, the international dialling code must be added to the subscriber number class.

In accordance with an embodiment of the invention, the provider of the telephone directory service uses the Build Tools system to create a new version of the class SubscriberNumber having the same name (SubscriberNumber) but the format and structure as laid out below.

class SubscriberNumber implements Entry
{
//field is public to show that it is key field
// this key field is the subscriberID
public String_subscriberID;
//these fields are private and contain the phone number in its various
// parts
private int_localCode;
private int_STDCode;
private int_internationalCode; //international code has been added
//accessors for private and keyFields
public int getSTD( );
public void setSTD(int newNumber);
public int getLocalNumber( );
public void setLocalNumber(int newNumber);
//accessors for international code have been added
public int getInternationalCode( );
public void setInternationalCode(int newCode);
//get full number has been added
public int getCompleteNumber( );
public String getSubscriberID( );
public void setSubscriberID( );
}

As can be seen from the foregoing, a number of fields in the class has been increased, in that a field for the international code has been added line 9. Further, new operations have been added getCompleteNumber line 19 including for the class SubscriberNumber. The foregoing version of this class may be termed version 2.

New international telephone number entries will be generated by the new service and which may be described by the following pseudo-code:

//create a new SubscriberNumber
SubscriberNumber subs = new SubscriberNumber( );
//set the new subscriber information
subs.setSubscriberID(“Jim”);
subs.setLocalCode(123456);
subs.setSTDCode(01789);
subs.setInternationalCode(001); //Jim's number is in the States
//write the entry into the space
objectSpace.write(subs, null, null);

The provider of the telephone directory service writes an updated version of the service which provides subscriber numbers with international codes and makes use of the version 2 class format. The version 2 class is packaged and located at an appropriate storage location which, in the preferred embodiment, is a part of the telephone directory service provider's website and designated with an appropriate URL.

FIG. 5 provides a schematic illustration of the logical server architecture for an embodiment of the invention. Application logic 92 includes a plurality of telephone directory services 93(1), 93(2) . . . 93(n), each representing a different class version and collectively referenced 93. For example, telephone directory service 93(1) corresponds to the first version of the SubscriberNumber class described above, and telephone directory service 93(2) refers to the second version of the SubscriberNumber class including international codes as described above. Each telephone directory service 93 can communicate with an Evolver module 100, described in detail hereinafter, which in the illustrated embodiment is shown separate from the application logic 92 and may reside in data access module 94. However, the Evolver 100 may be a part of the application logic 92 or split between the application logic 92 and data access module 94. Particular configurations are dependent upon the hardware and software architecture employed by the skilled person when implementing an embodiment of the invention. The telephone directory service 93 and Evolver 100 comprise transient Object Space 101.

Evolver 100 can communicate with a Werner 102, described in detail hereinafter, which itself can communicate with databases 96. Werner 102 provides a logical storage structure for Evolver 100, which utilises the non-volatile storage 97 comprising databases 96. The telephone directory services 93, Evolver 100 and Werner 102 (including non-volatile storage 97) comprise persistent Object Space 105.

Evolver 100 comprises a plurality of class version contexts/name spaces and corresponding class loaders (termed versioned class loaders) 109(1)-109(n), which correspond to each of the telephone directory services 93(1)-93(n). A class version context defines an execution environment for a corresponding class.

Together, Evolver 100 and Werner 102 comprise an Evolvable Object Space 103. The meaning of the term Evolvable Object Space 103 will become apparent from the later discussion of the operation of the Evolver 100 and Werner 102.

As mentioned above, an embodiment of the invention may be implemented in JAVA on a JAVA virtual mahcine. However, in conventional systems a class that had already been loaded onto the virtual machine running on the server, cannot be loaded again since that class has already been resolved onto that server. This is a restriction of object-oriented languages, particularly JAVA. This is the case even if the location, i.e. where the class is stored, changes or the location name changes.

However, an embodiment in accordance with a first aspect of the invention configures the merchant's server virtual machine to operate for different versions of the telephone directory service 93(1) . . . 93(n). As described in the foregoing, each version of the telephone directory service has the same name, “SubscriberNumber”, for the subscriber number object, but different fields and methods for each version of the subscriber number object. This is in direct conflict with the rules of object oriented languages, for example JAVA.

FIG. 6 schematically illustrates a merchant's server virtual machine configured to operate on different versions of the SubscriberNumber class, corresponding to different versions of telephone directory service. Each telephone directory service version, and corresponding SubscriberNumber class, may be instantiated on initialisation of the server, or may be added to the server over time as the type of telephone services offered by the merchant increases. The Evolver 100 is implemented on the virtual machine.

In the illustrated example five telephone directory services are instantiated, of which 93(1) and 93(3) are version 1, 93(2) and 93(4) are version 2 and 93(5) is version 3. Each telephone directory service uses the same name for the subscriber number class, i.e. SubscriberNumber. A client of the merchant communicates with the telephone directory service version for which they are configured. In an Internet or World Wide Web environment, a particular telephone directory service version is identified by an Uniform Resource Locator to which the client connects. Clients may only connect to a particular one of the telephone directory services, or may connect to any one of them, operating the same telephone directory service version as the client.

Each telephone directory service 93 is configured such that it can only communicate with one service connection entry point 170, e.g. 93(1) with 170(1), 93(2) with 170(2), 93(3) with 170(3), 93(4) with 170(4) and 93(5) with 170(5). Each service connection entry point 170 can only communicate with one VersionClassContext object, labelled 109(1), 109(2) and 109(3) for SubscriberNumber versions corresponding to telephone directory services 1, 2 and 3 respectively. As can be seen in FIG. 6, a VersionClassContext object 109 can communicate with more than one service connection entry point 170 for a telephone directory service of the same class version. Optionally, as illustrated in FIG. 5 not showing the intervening service connection entry points, each telephone directory service 93 has its own VersionClassContext object 109. The service connection entry points 170 and VersionClassContext objects 109 exist in the transient Object Space 101 illustrated in FIG. 5.

In accordance with an embodiment of the invention, a VersionClassContext 109 is an instance of a VersionClassContext class of the virtual machine running on the merchant's server and implementing the Evolver module 100 illustrated in FIGS. 5 and 6. As is well known to a person of ordinary skill in the art, a virtual machine, for example a JAVA virtual machine, includes what is known as a primordial (or general) class loader which loads by default all of the classes required by a JAVA application as it is run in the JAVA virtual machine. In accordance with an embodiment of the invention configured to provide specific class loading behaviour, and in particular to implement and load the VersionClassContext class, and behaviours at load times for specific sites or subsites of classes that are loaded, for the application or service.

Each VersionClassContext object 109 is an instance of a VersionClassContext class defined by the application or service designer, and runs in the server virtual machine. The VersionClassContext class includes fields for a SubscriberNumber version identifier, and a versioned class loader 172 which loads the SubscriberNumber class version corresponding to the identifier. The versioned class loader 172 loads all the necessary methods and entry interface to instantiate in the VersionClassContext SubscriberNumber objects of that class version.

Each versioned class loader 172(1), 172(2) and 172(3) maintains a record of the classes it has loaded. In a preferred embodiment, only one clas is loaded by each versioned class loader 172, that is to say the relevant SubscriberNumber class version.

Once a versioned class loader has loaded a class into a VersionClassContext object, and resolved, then another class having the same name cannot be loaded into that VersionClassContext object as this would create a namespace collision which would violate the rules of object oriented language. The SubscriberNumber class version loaded by the versioned class loader is a class of the VersionClassContext, and together with its methods creates a self-contained execution environment for SubscriberNumber objects of the the relevant class. Since the SubscriberNumber class is a class of the VersionClassContext object it is effectively isolated or hidden from other VersionClassContext objects. Thus, it can use a class having the same name as a class in another VersionClassContext object without any namespace collisions.

For each telephone directory service version 93 a separate VersionClassContext object, labelled 109(1), 109(2) and 109(3) in FIG. 6, can be instantiated and the corresponding SubscriberNumber class version loaded. In this way the same name, SubscriberNumber, can be used for different versions of a class within the same virtual machine without name space collisions since each VersionClassContext is separate from the other.

The coexistence of different class versions having the same class name within the same virtual machine is possible because the SubscriberNumber objects can only exist within their VersionClassContext. Creating an object of type SubscriberNumber outside of VersionClassContext would force the primordial or general class loader to load the associated class into the JVM and hence lock this namespace to that specific version of that class. This would effectively prevent other versions of the same class from being loaded, without the use of the namespace divisions provided by the VersionClassContext and more specifically its VersionClassLoader, no more versions of this class could be loaded.

In accordance with an embodiment of the invention, telephone directory services 93 communicate with the service connection entry points 170 using byte streams. Each service 93 can invoke a method which forms a byte stream of an object, in this case a SubscriberNumber. Such a method is known in JAVA and is called ObjectOutputStream. This method takes an object and forms a byte stream having a field for the class byte code and fields corresponding to the data entries of the object, i.e. subscriber name, local code and STD code for version 1 of the SubscriberNumber class. In embodiments of the present invention, the basic ObjectOutput Stream is modified to also include a field for a class version identifier known as the serial version uid (unique identifier). The modified ObjectOutputStream method is known as a VersionedObjectOutputStream since it includes information identifying the version of the object represented in the byte stream.

In a preferred embodiment of the invention, the serial version uid is generated by forming a hash of the class version byte code. This provides an unique identity or signature for the class version, since a small change in the class byte code will result in a large change in the hash result. Suitably, the hashing algorithm may be a method of the VersionedObjectOutput Stream, or one of its parent classes.

Taking service 93(1) as an illustrative example, a SubscriberNumber is serialised by invoking the VersionedObjectOutput Stream and sent to service connection entry point 170(1), which may be identified by an URL in an internet based environment for example. Although it is preferable that a telephone directory service is configured to communicate with only one service connection entry point, service 93(1) can be configured to communicate with any service connection point which communicates with SubscriberNumber version 1 VersionClassContext object 109(1), e.g. 170(3) shown in FIG. 6.

Service connection entry point 170(1) is configured to check the type and version of the object represented in the byte stream communicated to it, to check it is valid for that point, i.e. SubscriberNumber version 1. In the present example the check is positive, and the service connection entry point 170(1) checks to see if the corresponding VersionClassContext is instantiated. Suitably, this check is done by inspecting the record of loaded classes held by the class loader of the virtual machine. If the VersionClassContext 109(1) is present then service connection entry point 170(1) communicates the byte stream to it. Otherwise, service connection entry point 170(1) calls on the virtual machine class loader to load VersionClassContext version 1, and communicates the byte stream to it.

The virtual machine also supports the ByteStream class, which is one of the classes loaded either by the class loader or primordial class loader. Since SubscriberNumber objects are represented in the virtual machine in byte stream form, outside of the VersionClassContexts, different versions of the SubscriberNumber in this form can coexist in the virtual machine without name space collisions. Thus, different versions of SubscriberNumber objects can be communicated within the same virtual machine and stored in a standard format. Representation of an object in byte stream form is termed a class version neutral, or class type independent object. Each VersionClassContext object 109 includes a VersionedObjectOutputStream method, and also a VersionedObjectInputStream object. The VersionedObjectInputStream object is similar to, and may be a modification of, the ObjectInputStream object known from JAVA and in which the serial version uid is extracted from a byte stream input to it, together with reconstructing the object. Optionally, the serial version uid can be ignored and the method operate as a regular ObjectInputStream object by just reconstructing the object in accordance with the SubscriberNumber class instantiated for the VersionClassContext invoking the ObjectInputStream object. In this way, the VersionContextObject 109(1) can instantiate the SubscriberNumber sent by the telephone directory service 93(1).

When the telephone directory service is initiated, the merchant providing the service starts their server computer system 80 and a class version 1 telephone directory service, 93(1), is loaded onto the virtual machine running as part of the application logic 92. Class version/telephone directory service is loaded onto server computer system 80 using a class loader such as described above. Class loaders are well known in the art and form part of the run-time environment of the virtual machine, e.g. the JAVA platform. The class loader loads the software which defines the class and its function when instructed to do so by the telephone directory service at run-time. The telephone directory service and other classes are loaded from a class library which may be on a local storage device, or at a location on a network, or a combination of both.

Once the class version/telephone directory service is loaded, merchant proceeds to use the service to instantiate a number of subscriber number objects by writing a number of entries corresponding to respective subscriber number objects into the Object Space 101 as described above. The subscriber number objects, in their class version neutral form, are stored by way of Evolver 100 in the Werner 102. Optionally, clients may also populate Werner 102, via Evolver 100.

As described above, SubscriberNumber objects from the various versions of the telephone directory service 93(1)-93(n) are forwarded to appropriate service connection entry points in the Evolver 100 in a byte stream form. In a preferred embodiment of the present invention, back end 84 utilises the JAVA computing language and provides a JAVA run time environment for the Evolver 100 and Werner 102. JAVA provides a specific activity for turning the state of an object into raw bit data, and for turning bit data back into a formatted object. This activity is termed “Serialization” and JAVA provides object serialisation by means of ObjectInputStreams and ObjectOutputStreams for respectively turning an object state into raw data and turning raw data back to an object state. JAVA objects can declare that they may be converted to and from byte streams by implementing the “Serializable” interface provided in the JAVA programming language. The Serializable interface is a so-called marker interface that is simply a “message” to the JAVA virtual machine (compiler and run time environment), that the object may be turned to and from a raw data stream. In the preferred embodiment, SubscriberNumber 104 contains such a marker interface indicating that it may be turned to and from a raw data stream.

As described above, in accordance with an embodiment of the invention, ObjectInputStream and ObjectOutputStream are class version sensitive, and are respectively termed VersionedObjectInputStream and VersionedObjectOutputStream. For a JAVA runtime environment ObjectInputStream and ObjectOutputStream may be modified or extended to be class version sensitive. Optionally, new methods for VersionedObjectInputStream and VersionedObjectOutputStream may be created, either in JAVA or other suitable object-oriented programming language such as may be selected by the skilled person.

A user may also create new SubscriberNumbers, and could use code such as described above to create SubscriberNumber objects for a particular SubscriberNumber version and send them to the telephone directory service 93(1), for populating Evolvable Object Space 103.

The process flow for the merchant virtual machine implementing an embodiment of the invention will now be described with reference to FIG. 7. At step 200 a byte stream representative of a SubscriberNumber object 104 is communicated from a telephone directory service 93 to an associated service connection entry point 170 as an entry object. The service connection entry point 170 checks the version of the class of the SubscriberNumber represented by the byte stream entry object at step 202. In an optional embodiment, the serial version uid can include information about the class type and not just the version. This is done by inspecting the serial version uid included in the byte stream, and checking it corresponds to the VersionClassContext with which the service connection entry point communicates. Then at step 204 the service connection entry point 170 checks whether the corresponding VersionClassContext for the version, and optionally the type, is instantiated in the Evolver 100.

If the result of the check at step 204 is NO then the process flows to step 206 where the Evolver 100 instantiates the required VersionContextObject, and the associated SubscriberNumber class version is loaded into the VersionContextObject by its versioned class loader at step 208.

The process then flows to step 210, which is also the next step in the process for the result at step 204 being YES. At step 210 the byte stream representing the SubscriberNumber object 104 is forwarded to the corresponding VersionClassContext, where it is converted back into SubscriberNumber object 104 using the versioned object input stream. The SubscriberNumber object 104 now exists within the virtual machine implementing Evolver 100, but is isolated by its VersionClassContext object from SubscriberNumbers of different versions elswhere in the Evolver virtual machine.

At step 212 the SubscriberNumber object 104 is converted into class neutral form and packed into a “Box”. A “label” describing the contects of the Box is applied to the Box at step 214, and the Box shipped to Werner 102 for storage in the database 96 at step 216.

FIG. 8 schematically illustrates the Evolvable Object Space 103, and the functions of the Evolver 100 and the Werner 102. The process flow within the Evolver 100 and Werner 102 will now be described in more detail with reference to FIG. 8.

The SubscriberNumber object 104 enters a “de-classing” module 106 where it is stripped of its class structure and represented in a “raw” class independent format byte stream. That is to say, the object is represented as a continuous pattern or stream of bits or bytes. Module 106 creates a data block including a representation of a class name, class byte code, version ID and location of the SubscriberNumber class. Additionally, the object state is represented in “raw” form. Typically, representation of the object state in “raw” form is done on a field-by-field basis.

Module 106 implements a versioned object output stream as described above to take the subscriber number object 104 and output a byte array of raw data that represents that object. This byte array is then forwarded to the packaging module 108, to form the contents of the box 110. Box 110 is an object of a runtime class “Box”, and comprises a “label” field applied to it by packaging module 108 which, in the preferred embodiment, comprises fields indicating the class name, superclass structure and at least one key field for the object represented in byte array form in the contents of the box. In a preferred embodiment, the versioned object output stream includes in the byte stream the version id. Optionally, the version id may be included on the label. The label is “filled out” by a versioned object output stream which derives the information from the VersionContextObject corresponding to the telephone directory service 93 submitting the SubscriberNumber to the Evolver 100. That is to say, the versioned object output stream as knowledge of the version and class name for example, since it is dedicated to the partiular VersionClassContext object, and also knows the subscriber identity information from the SubscriberNumber object 104. Box 110 also includes a field comprising raw data corresponding to the object state. A person of ordinary skill in the art will understand that the box may be formatted in any other suitable way.

By enclosing SubscriberNumber 104 in Box 110, an object has been created which, whilst representative of SubscriberNumber 104, is not constrined by it's the SubscriberNumber object structure. In this respect, Box 110 is independent or neutral of the SubscriberNumber type or class version, and Evolver 100 may be said to provide a SubscriberNumber type and/or class version independent of, or neutral to, the object-oriented, execution environment and Box 110 can be written into the Evolvable Object Space 103, which is independent of the type and/or class version of SubscriberNumber.

Box 110 is then stored in Werner 102, preferably in accordance with the class name. Figuratively, in a preferred embodiment, Werner 102 can be represented as a series of shelves 112, 114 and 116 for Boxes relating to respective classes. For the present example, the class name is “SubscriberName” and has a superclass structure i.e. a parent class “Address”. The keyfield is the “SubscriberID”. An example of such a Box is shown stored on shelf 112.

Shelf 114 shows a Box relating to another class which may be stored in Werner 102. In this instance, the Box relates to an object of the class type “subscriber_Zip” representing a subscriber's Zip code. This Box has the same superclass structure of “Address”, since the “SubscriberZip” class may be considered to be a child of the “Address” class. The keyfield is again the “_SubscriberID” field. Shelf 116 shows us a box having a generic label stored in the Werner 102. Storage of Boxes containing different object types clearly indicates the object independent environment of Werner 102 and Evolvable Object Space 103.

Optionally, Werner 102 does not have to be organised by “shelves”, but may have a tree structure. The Werner 102 need not have any organisation by type, but may be merely a list of boxes. The ordinarily skilled person would understand that the foregoing described shelf structure is an optimisation of a general form of storage, to assist lookup by type, and embodiments of the invention are not limited to such a structure.

Thus, it has been illustrated that a SubscriberNumber object 104 may be modified and stored in a class independent format, devoid of its class structure, as the contents of a Box 110. For an environment in which Boxes corresponding to more than one class are to be stored, the Box label provides an indication of the class name, class version and at least one key or index field for the Box contents. It will be readily apparent that it is not necessary to provide indications on the label of a superclass structure, but the inclusion of such an indicator enhances the searchability of the data stored in Werner 102 by super class type as well as class type.

In an embodiment for which only one class will be stored in Werner 102, then the class name indicator may be dispensed with.

Storage media for Werner 102 may be implemented using an object-oriented or relational database. Further, Werner 102 may comprise a transient storage space, i.e. the boxes are held in a volatile memory such as RAM or may be a persistent space in which the boxes are stored in non-volatile memory to form a database. Preferably, a persistent ObjectSpace comprises a Werner 102 that uses non-volatile storage space so that if server 80 should fail, then the data stored in the Werner of a persistent space is not lost.

As described above, in the preferred embodiment the merchant server 80 supports a plurality of telephone directory service versions 93(1), 93(2) . . . 93(n), each service version corresponding to and running a respective class version of SubscriberNumber. Each version of service will use a different version on an Entry through the same version of the space Interface (API) for server 80. The different versions of service are suitably located at different URLs, or located in jars at different class path locations and name contributions, so that a client of the merchant will access the appropriate URL for the version of service they are using. A client accesses the version of service they wish to use by addressing the appropriate URL in their browser 90. Optionally, a client rnay be provided with application software which automatically configures Browser 90 to address the appropriate URL for the version of the client's application software.

Thus, the version of service used by a client is defined by the client either automatically or by inputting a suitable URL or class path. The service requested by a client defines the version information, since it is implicit in the class version for the requested service.

By way of the plurality of telephone directory service versions 93, the application logic 92 can fulfil and implement different aspects of the merchant's telephone directory services, and manages handling of multiple class versions including the creation and storage of subscriber numbers.

Retrieval of a subscriber number from storage will now be described. In response to a request for a SubscriberNumber, reconstruction of the raw data into an object class format utilises the class version identifier on the label to gain full knowledge of the original object format of the object stored in the box. That is to say, as to what class version the object belongs to, and formats the raw data appropriately. Evolver 100 also has a knowledge of the class version utilised by the requesting browser 90, since the version of the service and hence the class version, used in the request by the client is in accordance with, and corresponding to, the version of service the client is using. In the described embodiments, the client can only connect to a VersionClassContext corresponding to its service version. Consequently, the versioned object input stream of the corresponding VersionClassContext retrieves and transforms the byte array forming the contents of box 110 into a class version corresponding to the class version of the VersionClassContext, i.e. that utilised by the service version of the requesting browser 90, since it has information as to the fields in the byte classes since it knows the requesting class version. Thus, a subscriber number object 122 is output from Evolver 100 which has the class structure corresponding to the class version utilised by the requesting browser 90, irrespective of the class version form or under which the object corresponding to the requested subscriber number was created. Thus, it may be seen that a browser running a virtual machine implementing an environment for a particular class version may request subscriber numbers which are created by another virtual machine, e.g. the merchant's virtual machine, operating under another class version, and have that subscriber number returned to it in a format consistent with the class version utilised by the virtual machine from which the request was made.

In an optional embodiment class version information is contained in the request for a subscriber number sent by the requesting browser 90 to the web server 86. The class version information obtained in this way may then be used to transform objects into the class version used by the requesting browser 90.

Operation of the telephone directory service will now be considered in more detail.

Population of a telephone directory service 93 with subscriber numbers will now be described with reference to the flow diagram illustrated in FIG. 9. The merchant or a client can populate a telephone directory service 93 with new SubscriberNumbers. The merchant will typically request or use the most up-to-date version of the telephone directory service. A client will use whichever service for which it is configured, and access a corresponding URL or class path, for example.

All of the plurality of telephone directory services 93 may be running in application logic 92 continuously. Optionally, only those services which have been requested by clients may be running, and will cease once the client's request has been serviced. For the latter situation, web server 86 calls a versioned class loader which loads the version of class used by the requested telephone directory service into the virtual machine on which the application logic resides, step 130. SubscriberNumber objects sent to the telephone directory service are converted into serialized form and are then input to the Evolver from the telephone directory services, their class version is identified, and the serialized stream is passed to the appropriate VersionContextObject in the Evolver. For both situations, the service connection entry point utilises the URL for the location of the version class context class corresponding to the requested telephone directory service and calls on the Evolver virtual machine class loader to load the appropriate class into the Evolver 100 from the appropriate webserver. The VersonClassContext object then calls its versioned class loader to load the SubscriberNumber class into the VersionClassContext object, thereby instantiating the class. The byte streams representative of SubscriberNumbers form Entries for the VersionClassContext and are written to the appropriate VersionClassContext objects in byte stream form at step 132. for SubscriberNumber objects 104 are instantiated within that VersionClassContext by inputting them to the versioned object input stream to, thereby populating the Evolvable Object Space 103. At step 134, the versioned oSubscriberNumber object by translating the object into binary format.

The binary format represents the state of the object, and for a version 1 SubsciberNumber object represents the fields LocalCode and STDCode, whilst for a version 2 SubscriberNumber object the field InternationalCode is also represented in binary form.

The binary format of the object is “boxed” at step 136, and a label applied to the Box comprising the class name, superclass structure and key field, for example. The class name, version id, superclass structure and key field may be obtained from the SubscriberNumber object 104 prior to or as part of its serialisation at step 134. The boxed class may then be sent to Werner 102 for storage at step 138.

Sending the Box to Werner 102, at step 138 of the flow diagram illustrated in FIG. 9, initiates a storage service for storing boxes in the Werner which operates in accordance with the flow diagram illustrated in FIG. 10. At step 140, the werner 102 receives the Box from Evolver 100 and reads the label on the Box at step 142. The Box is then stored in Werner 102 according to the information label, at step 144.

Suitably, Evolver 100 and Werner 102 engage in a handshaking protocol to firstly alert the Werner to the fact that a box is to be transmitted to it, and secondly to confirm to the Evolver that the box has been received and stored.

In accordance with the foregoing, an execution and storage environment is created in which objects within different class versions may be manipulated and stored. Furthermore, the Evolver and Werner do not need to be updated each time a new telephone directory service version is created. All that is required is that the appropriate class is loaded into the Evolver corresponding to the service version being utilised. Furthermore, clients do not need to update their service version.

Simultaneous loading of different class versions of the telephone directory service onto the virtual machine on which the application logic 92 and Evolver run is prohibited in order to avoid name space collisions. However, it is often the case that it is necessary or desirable to have more than telephone directory service running at the same time. Typically, this is achieved by having a plurality of virtual machines running at any one time, each corresponding to a telephone directory service, in order that the application logic may service plural requests in different class versions simultaneously, and pass such requests to the Evolver, running as a single virtual machine, which is configured to handle multiple class versions within the same virtual machine.

In the foregoing described embodiments, clients do not need to update their version of the telephone directory service unless they wish to use updated features, e.g. international dialling compared to just national dialling.

Thus, there may be two categories of user: the first category being users who are satisfied with a telephone directory service in which just STD codes and local numbers are available and operate software under the original version 1 class environment (93(1)); the other users being new users who are provided with version 2 class software (93(2)), or have upgraded their original software to version 2 class software (93(2)) in order to have access to the telephone directory service including international dialling codes in the subscriber number.

In an optional embodiment, users of the telephone directory service may all update their telephone directory service interface software to operate in a new, e.g. version 2, class environment. For such an optional embodiment, only the current or most up-to-date telephone directory service need be run in application logic 92.

An example of the operation of a preferred embodiment of the invention responding to a client request for a SubscriberNumber will now be described with reference to FIG. 11. When a client 90 transmits a request to the merchant server 80, including a subscriber identity, it does so in the form of a template for an object in the class version under which the client is operating. The request also contains the URL for the telephone directory service 93 used by the client. In this example, the client is using version 2 of the telephone directory service.

The appropriate telephone directory service 93(2) is accessed or loaded into application logic 92 in response to the client request. At step 146, a requested subscriber number object arrives at the Evolver 100 via the telephone directory service 93(2) in the form of a serialised template entry, and including information about the class structure corresponding to version 2, i.e. corresponding to the version class context of the request. The serialised template is forwarded from the service connection entry point receiving it to the corresponding VersionClassContext object in the Evolver, where it is converted into a template object by the versioned object input stream, and then converted into a class version neutral object by the versioned object output stream. Next, at step 148, the class version neutral object for the template is forwarded to Werner 102 and is searched against the class (SubscriberNumber) and subscriber identity. Once a Box 110 matching the class and subscriber ID has been identified in the Werner 102, then the Box 110 is returned to the VersionClassContext corresponding to the originating request, i.e. version 2 in Evolver 100, where it is input to the corresponding versioned object input stream, step 150. In this example, Box 110 returned to the Evolver comprises a binary representation of an object of SubscriberNumber class but of version 1. That is to say, a Box representing an object created by the old service version. Thus, the class version context of the request (version 2) conflicts with the class context of the object represented in binary form in the Box returned from Werner 102. Since the context of the request is class version 2 and the user requesting the subscriber number operates in a version 2 environment using telephone directory service 93(2), a new object of class type SubscriberNumber and version 2 is created from the contents of Box 110. The creation of the new object is achieved by the versioned object input stream 120 of Evolver 100.

The context of the request is known to the Evolver 100 from the template supplied to it in the request, and thus the versioned object input stream is able to create a new object of type SubscriberNumber version 2 for the request. In a preferred embodiment, each VersionClassContext include a list of all the different class versions, and their stucture. This list is updated as new class versions are created. Optionally, the context of the request is known since it is made, via an appropriate service connection entry point to a particular VersionClassContext object. Thus, the VersionClassContext version 2 versioned object input stream can examine the serialised byte stream returned from the Werner, and know where each element of the version 1 class is held so that it can extract the relevant data and form a version 2 SubscriberNumber.

At step 152, the retrieved Box is unpacked and its serial version id written into the VersionContextObject. Some or all of the other information on the label may also be written to the VersionContextObject. The VersionContextObject now contains a field containing the retrieved object version in byte or bit stream form.

At step 154, the raw byte or bit stream form of the Box contents are fed to the versioned object input stream. At step 156 versioned object input stream converts the binary version of the object into a class versioned object in accordance with the class context of the request and the class version of the stored object as derived from VersionContextObject. The old version of the class is used to fill out the details of the requesting Entry, i.e. request for a SubscriberNumbetr, and default values are entered for the new fields in the new version of the class. Initially, the versioned object input stream takes the binary raw data and attempts to populate the requesting Entry by moving the values contained in the raw byte stream into the appropriate fields within it. As for the present example in which the request is a version 2, if new fields have been added to the Entry, the versioned object input stream inserts a default “null” value into those fields. Thus, the requesting Entry effectively forms a new version of the SubscriberNumber object, version 2, and can be made available, step 150, to the user requesting the subscriber number. If the requesting context and retrieved context are the same, then no conversion is necessary. In the preferred embodiment, the requesting Entry is in the form of a SubscriberNumber template such that when the template fields are populated it forms a SubscriberNumber object

A new class, such as telephone directory service 93(2), may implement a readobject( ) method. If such a method has been implemented then it will be called by the underlying implementation of the versioned object input stream. In the foregoing described example, telephone directory service 93(2) implements a readobject( ) method to substitute a default value into its International Code field for conversions from version objects. Thus, the code +44 is added to the content of the SubscriberNumber converted from version 1 to version 2. If the readObject( ) method is not implemented by telephone directory Service 92(2) then the default value of the InternationalCode field would be null.

Embodiments of the invention are not limited to including a readobject( ) method as described above. If specialised behaviour is required during the conversion process, it is possible to configure a requesting Entry to implement such specialised behaviour which may be specific to a particular class type and/or version. The method may be different for conversions between different versions of a class. The methods enable values to be substituted into a class version field within its own version context.

In a preferred embodiment of the invention, the new SubscriberNumber object converted into class version 2 format is used to create a new Box for manipulating and storing the object in Evolvable Object Space 103. In this way, the originally created and stored object has its version “moved forward” into the new version of service, version 2. This is achieved by applying the VersionedObjectOutputStream to the newSubscriberNumber object in version 2, and following steps 134 to 138 of the flowchart illustrated in FIG. 6, to create a new Box representing version 2 object for storage in Werner 102.

Optionally, the retrieved Box is replaced in Werner 102 unchanged.

Insofar as embodiments of the invention described above are implementable, at least in part, using a software-controlled programmable processing device such as a Digital Signal Processor, microprocessor, other processing devices, data processing apparatus or computer system, it will be appreciated that a computer program for configuring a programmable device, apparatus or system to implement the foregoing described methods is envisaged as an aspect of the present invention. The computer program may be embodied as source code and undergo compilation for implementation on a processing device, apparatus or system, or may be embodied as object code, for example. The skilled person would readily understand that the term computer in its most general sense encompasses programmable devices such as referred to above, and data processing apparatus and computer systems.

Suitably, the computer program is stored on a carrier medium in machine or device readable form, for example in solid-state memory or magnetic memory such as disc or tape and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

In view of the foregoing description it will be evident to a person skilled in the art that various modifications may be made within the scope of the invention. For example, the foregoing embodiments of the present invention may be implemented in object-oriented programming languages other than JAVA, for example Smalltalk. Additionally, embodiments of the invention are not restricted to utilisation within an e-commerce environment on the Internet, but may be applied to any application in which upgrading of class versions is necessary, together with the maintenance of services using previous class versions. Additionally, the use of readObject( ) methods called by the VersionedObjectInputStream have been described. Such methods may also be called by the VersionedObjectOutputStream to implement particular behaviour when forming the raw data. The binary representation of the objects may be in bit or byte stream form.

It is clear that embodiments of the present invention may include more than two versions of a class or object, and more than two service connection entry points.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

1. A method of operating a data processing apparatus to provide an object-oriented execution environment operable for first and second versions of the same lass, said method comprising:
configuring said object-oriented execution environment to communicate with first and second services, said first service operative in accordance with said first version of the same class and said second service operative in accordance with said second version of the same class; and
further configuring said object-oriented execution environment to permit said first service to communicate only with a first version execution environment operative in accordance with said first version of the same class, and to permit said second service to communicate only with a second version execution environment operative in accordance with said second version of the same class.

2. A method according to claim 1, further comprising configuring said object-oriented execution environment to permit a third service operative in accordance with said first version of the same class to communicate only with said first version execution environment.

3. A method acording to claim 1 or 2, further comprising configuring said object-oriented execution environment to instantiate a first class context object including a first versioned class loader corresponding to said first version of the same class for establishing said first version execution environment, and to instantiate a second class context object including a second versioned class loader corresponding to said second version of the same class for establishing said second version execution environment.

4. A method according to claim 3, wherein said first versioned class loader comprises a method for implementing said first version of said same class to establish said first version execution environment in said object-oriented execution environment, and said second versioned class loader comprises a method for implementing said second version of said same class to establish said second version execution environment in said object-oriented execution environment.

5. A method according to claim 3 or 4, wherein said first version class loader includes a method for establishing an entry interface for said first version of the same class, said second version class loader includes a method for establishing an entry interface for said second version of the same class.

6. A method according to any one of claims 3 to 5, wherein said first and second version class loaders are operable to configure respective said first and second version execution environments to implement respective first and second versioned object input streams, said first versioned object input stream operable to receive a bit stream representative of a corresponding object in accordance with said first version of the same class and to output an object of said first version of the same class, and said second versioned object input stream operable to receive a bit stream representative of an object in accordance with said second version of the same class and to output a corresponding object of said second version of the same class.

7. A method according to any preceding claim, comprising configuring said object-oriented execution environment to keep a record of first and second version execution environments operable for said object-oriented execution environment, and to check a service call on said object-oriented execution environment against said record to determine which of said first or second service is making said call and to arrange for communication between a service originating said service call and one of said first or second version execution environments in dependence on a result of said check.

8. A method according to claim 3 or any one of claims 4 to 7 dependent on claim 3, further comprising configuring said object-oriented execution environment to load said first versioned class loader responsive to a service call from said first service.

9. A method according to claim 8, further comprising configuring said object-oriented execution environment to load said second versioned class loader responsive to a service call from said second service.

10. A method according to any preceding claim, further comprising configuring said object-oriented execution environment to provide first and second connection points, said first connection point arranged to permit said communication between said first service and said first version execution environment, and said second connection point arranged to permit said communication between said second service and said second version execution environment.

11. A method according to claim 10 dependent on claim 2, further comprising configuring said object-oriented execution environment to provide a third connection point corresponding to said third service, said third connection point arranged to permit said communication between said third service and said first version execution environment.

12. A method according to claim 10 or claim 11, wherein said first service is configured to communicate with only said first connection point of said first and second connection points, and said second service is configured to communicate with only said second connection point of said first and second connection points.

13. A method acording to claim 11 or claim 12 dependent on claim 11, wherein said third service is configured to communicate with only said third connection point of said first, second and third connection points,

14. A method according to any preceding claim, further comprising configuring said object-oriented execution environment to be responsive to a service call associated with a class version identifier.

15. A method according to claim 14, further comprising configuring said object-oriented execution environment to determine if a service call corresponds to said first or second version of said same class by inspection of said class version identifier associated with said service call.

16. A method according to claim 14 or claim 15, further comprising configuring said object-oriented execution environment to form said class version identifier from a hash of the byte code defining a corresponding version of the same class.

17. A method according to any one of claims 3 to 16 dependent on claim 3 wherein said first and second version class loaders are operable to configure said first and second version execution environments to remove class structure from an object instantiated in respective said first or second version execution environments to form a class version neutral object, and to associate an object identifier and a class version identifier with said class version neutral object.

18. A method according to claim 17, wherein said first and second version class loaders are operable to configure respective said first and second version execution environments to associate a class identifier with said class version neutral object.

19. A method according to claim 17 or 18, wherein said first and second version class loaders are operable to configure respective said first and second version execution environments to remove said class structure to form said class version neutral object by forming a bit or byte stream representative of said object.

20. A method according to any one of claims 3 to 19 dependent on claim 3, wherein said first and second version class loaders are operable to configure respective said first and second version execution environments to implement respective first and second versioned object output streams, said first versioned object output stream operable to receive an object of said first version of the same class and to output a bit or byte stream representative of said object of said first version of the same class and a first version identifier, and said second versioned object output stream operable to receive an object of said second version of the same class and to output a bit or byte stream representative of said object of said second version of the same class and a second version identifier, thereby to create a class version neutral object.

21. A method according to claim 19 or 20, wherein said first and second version class loaders are operable to configure said first and second version execution environments to include said class version identifier in said bit or byte stream.

22. A method according to any one of claims 19 to 21, said first and second version class loaders are operable to configure said first and second version execution environments to create said class version neutral object comprising an object identifier field, a class version identifier field and a field including said bit or byte stream.

23. A method according to claim 22, said first and second version class loaders are operable to configure said first and second version execution environments to create said class version neutral object further comprising a class name field indicative of the class of said object.

24. A method according to any one of claims 17 to 23, further comprising storing said class version neutral object.

25. A method according to claim 24, further comprising associating an index key with said class version neutral object indicative of the contents thereof.

26. A method of operating a data processing apparatus configured in accordance with claim 24 or 25, further comprising retrieving said class version neutral object from storage and converting said class version neutral object into a different class version object corresponding to a different class version to that class version from which said class version neutral object was formed.

27. A method according to claim 26, wherein said converting comprises populating a field of said different class version object with data from a corresponding field derived from said class version neutral object in accordance with said object identifier and class version identifier associated with said class version neutral object.

28. A method according to any one of claim 26 or 27, wherein said converting further comprises populating a field of said different class version object having no corresponding field in said class version neutral object with a default value.

29. A method according to any one of claims 26 to 28, wherein said first and second versioned object input streams are operable to recognise a version identifier in an input bit or byte stream, said method further comprising:
receiving a request from said first service to retrieve a stored object corresponding to an object identifier included in said request;
communicating said request to said first version execution environment;
retrieving a stored class version neutral object corresponding to said object identifier and placing it in said first version execution environment;
inputting said retrieved class version neutral object to said first versioned object input stream and identifying the class version associated with said retrieved class version neutral object as said second version of said same class; and
converting said class version neutral object into an object in accordance with said first version.

30. A method according to claim 29, further comprising said first versioned object input stream instantiating and populating the fields of an object of said first version of the same class with data corresponding to data held in corresponding fields of said retrieved class version neutral object as identified in accordance with said class version identifier.

31. A method according to claim 30, further comprising said first versioned object input stream populating fields of said object of said first version of the same class with null data for said retrieved class version neutral object comprising no corresponding field.

32. A method according to claim 31, further comprising inputting said object in accordance with said first version converted from said second version to said first versioned object output stream to form a class version neutral object comprising a bit or byte stream representative of said first version object, and storing said class version neutral object.

32. A method for configuring a data processing apparatus for processing a class typed object in accordance with a class type version structure, comprising:
configuring said data processing apparatus with a versioned class loader for loading said class type version to provide a class type version execution environment;
providing said class type version execution environment corresponding to said class typed object;
receiving said class typed object;
removing class type structure from said class typed object to form an object independent of said class type version; and
associating a class typed object identifier and a class type version identifier with said class type version independent object.

33. A computer program product comprising machine or computer-readable program element for configuring a data processing apparatus or computer to implement a method according to any one of claims 1 to 32.

34. A computer program product comprising machine or computer-readable program elements translatable to configure a data processing apparatus or computer to implement a method according to any one of claims 1 to 32.

35. A computer carrier medium carryig a computer program product according to claim 33 or 34.

36. A data processing apparatus for providing an object-oriented execution environment operable for first and second versions of the same class, said data processing apparatus configured to:
communicate with first and second services, said first service operative in accordance with said first version of the same class and said second service operative in accordance with said second version of the same class;
to permit said first service to communicate only with a first version execution environment operative in accordance with said first version of the same class; and
to permit said second service to communicate only with a second version execution environment operative in accordance with said second version of the same class.

37. Apparatus according to claim 36, further configured to permit a third service operative in accordance with said first version of the same class to communicate only with said first version execution environment.

38. Apparatus according to claim 36 or 37, further configured to instantiate a first class context object including a first versioned class loader corresponding to said first version of the same class for establishing said first version execution environment, and to instantiate a second class context object including a second versioned class loader corresponding to said second version of the same class for establishing said second version execution environment.

39. Apparatus according to claim 38, wherein said first versioned class loader is configured to implement said first version of said same class to establish said first version execution environments in said object-oriented execution environment, and said second versioned class loader is configured to implement said second version of said same class to establish said second version execution environments in said object-oriented execution environment.

40. Apparatus according to claim 38 or 39, wherein said first version class loader is configured to establish an entry interface for said first version of the same class, said second version class loader is configured to establish an entry interface for said second version of the same class.

41. Apparatus according to any one of claims 38 to 40, wherein said first and second version class loaders configure respective said first and second version execution environments to implement respective first and second versioned object input streams, said first versioned object input stream operable to receive a bit stream representative of a corresponding object in accordance with said first version of the same class and to output an object of said first version of the same class, and said second versioned object input stream operable to receive a bit stream representative of an object in accordance with said second version of the same class and to output a corresponding object of said second version of the same class.

42. Apparatus according to any one of claims 36 to 41, wherein said object-oriented execution environment is configured to keep a record of first and second version execution environments operable for said object-oriented execution environment, and to check a service call on said object-oriented execution environment against said record to determine which of said first or second service is making said call and to arrange for communication between a service originating said service call and one of said first or second version execution environments in dependence on a result of said check.

43. Apparatus according to claim 38 or any one of claims 39 to 42 dependent on claim 38, wherein said object-oriented execution environment is further configured to load said first versioned class loader responsive to a service call from said first service.

44. Apparatus according to claim 43, further comprising configuring said object-oriented execution environment to load said second versioned class loader responsive to a service call from said second service.

45. Apparatus according to any one of claims 36 to 44, wherein said object-oriented execution environment is further configured to provide first and second connection points, said first connection point arranged to permit said communication between said first service and said first version execution environment, and said second connection point arranged to permit said communication between said second service and said second version execution environment.

46. Apparatus according to claim 45 dependent on claim 37, wherein said object-oriented execution environment is configured to provide a third connection point corresponding to said third service, said third connection point arranged to permit said comunication between said third service and said first version execution environment.

47. Apparatus according to claim 45 or claim 46, wherein said first service is configured to communicate with only said first connection point of said first and second connection points, and said second service is configured to communicate with only said second connection point of said first and second connection points.

48. Apparatus according to claim 46 or claim 47 dependent on claim 46, wherein said third service is configured to communicate with only said third connection point of said first, second and third connection points,

49. Apparatus according to any one of claims 36 to 48, wherein said object-oriented execution environment is configured to be responsive to a service call associated with a class version identifier.

50. Apparatus according to claim 48, wherein said object-oriented execution environment is configured to determine if a service call corresponds to said first or second version of said same class by inspection of said class version identifier associated with said service call.

51. Apparatus according to claim 49 or claim 50, wherein said object-oriented execution environment is configured to form said class version identifier from a hash of the byte code defining a corresponding version of the same class.

52. Apparatus according to any one of claims 39 to 51 dependent on claim 39 wherein said first and second version class loaders are operable to configure said first and second version execution environments to remove class structure from an object instantiated in respective said first or second version execution environments to form a class version neutral object, and to associate an object identifier and a class version identifier with said class version neutral object.

53. Apparatus according to claim 52, wherein said first and second version class loaders are operable to configure respective said first and second version execution environments to associate a class identifier with said class version neutral object.

54. Apparatus according to claim 52 or 53, wherein said first and second version class loaders are operable to configure respective said first and second version execution environments to remove said class structure to form said class version neutral object by forming a bit or byte stream representative of said object.

55. Apparatus according to any one of claims 39 to 54 dependent on claim 39, wherein said first and second version class loaders are operable to configure respective said first and second version execution environments to implement respective first and second versioned object output streams, said first versioned object output stream operable to receive an object of said first version of the same class and to output a bit stream representative of said object of said first version of the same class and a first version identifier, and said second versioned object output stream operable to receive an object of said second version of the same class and to output a bit stream representative of said object of said second version of the same class and a second version identifier, thereby to create a class version neutral object.

56. Apparatus according to claim 54 or 55, wherein said first and second version class loaders are operable to configure said first and second version execution environments to include said class version identifier in said bit or byte stream.

57. Apparatus according to any one of claims 52 to 56, wherein said first and second version class loaders are operable to configure said first and second version execution environments to create said class version neutral object comprising an object identifier field, a class version identifier field and a field including said bit or byte stream.

58. Apparatus according to claim 57, wherein said first and second version class loaders are operable to configure said first and second version execution environments to create said class version neutral object further comprising a class name field indicative of the class of said object.

59. Apparatus according to any one of claims 52 to 58, further configured to store said class version neutral object.

60. Apparatus according to claim 59, further configured to associate an index key with said class version neutral object indicative of the contents thereof.

61. Apparatus configured in accordance with claim 59 or 60, and further configured to retrieve said class version neutral object from storage and to convert said class version neutral object into a different class version object corresponding to a different class version to that class version from which said class version neutral object was formed.

62. Apparatus according to claim 61, further configured to populate a field of said different class version object with data from a corresponding field derived from said class version neutral object in accordance with said object identifier and class version identifier associated with said class version neutral object.

63. Apparatus according to any one of claim 61 or 62, further configured to populate a field of said different class version object having no corresponding field in said class version neutral object with a default value.

64. Apparatus according to any one of claims 61 to 63, wherein said first and second versioned object input streams are operable to recognise a version identifier in an input bit or byte stream, said apparatus further configured to:
receive a request from said first service to retrieve a stored object coresponding to an object identifier included in said request;
communicate said request to said first version execution environment;
retrieve a stored class version neutral object corresponding to said object identifier and place it in said first version execution environment;
input said retrieved class version neutral object to said first versioned object input stream and identify the class version associated with said retrieved class version neutral object as said second version of said same class; and
convert said class version neutral object into an object in accordance with said first version.

65. Apparatus according to claim 64, said first versioned object input stream configured to instantiate and populate the fields of an object of said first version of the same class with data corresponding to data held in corresponding fields of said retrieved class version neutral object as identified in accordance with said class version identifier.

66. Apparatus according to claim 65, said first versioned object input stream further configured to populate fields of said object of said first version of the same class with null data for said retrieved class version neutral object comprising no corresponding field.

67. Apparatus according to claim 66, further configured to input said object in accordance with said first version converted from said second version to said first versioned object output stream to form a class version neutral object comprising a bit or byte stream representative of said first version object, and to store said class version neutral object.

68. A data processing apparatus for processing a class typed object in accordance with a class type version structure, configured to:
include a versioned class loader for loading said class type version to provide a class type version execution environment;
provide said class type version execution environment corresponding to said class typed object;
receive said class typed object;
remove class type structure from said class typed object to form an object independent of said class type version; and
associate a class typed object identifier and a class type version identifier with said class type version independent object.

69. A computer system network, comprising:
data processing apparatus according to any one of claims 36 to 68 for providing a server computer system; and
a client computer system operable to communicate with said server computer system;
said client computer system comprising means for establishing communication with said server computer system for operation in a first or second class version defined by said client computer system.

70. A computer system network according to claim 69, said server computer system responsive to a communication with said client computer system to load said first or second class version in dependence on said client computer system from a class version storage medium.

71. A computer system network according to claim 70 and operable for an Internet, said class version storage medium corresponding to a URL communicated to said server from said client.

72. A method substantially as hereinbefore described for respective embodiments and with reference to respective Figures of the Drawings.

73. A computer program substantially as hereinbefore described for respective embodiments and with reference to respective Figures of the Drawings.

74. Data processing apparatus substantially as hereinbefore described for respective embodiments and with reference to respective Figures of the Drawings.

75. A computer system substantially as hereinbefore described for respective embodiments and with reference to respective Figures of the Drawings.
